(19) United States
(12) Patent Application Publication
(10) Pub. No.: US 2001/0046437 A1
(43) Pub. Date: Nov. 29, 2001

(54) Automated system for storing or dispensing stackable goods

(76) Inventors: A. Mark Bramwell, Sebastopol, CA (US); Richard Batchelor, Dublin, CA (US); Peter Michael Lind, Yountville, CA (US); James Happ, Glen Ellen, CA (US)

Correspondence Address: FINLEY & BERG, LLP, 455 MARKET STREET, SUITE 1940, SAN FRANCISCO, CA, 94105-2448, US

(21) Appl. No.: 09/733,705

(22) Filed: Dec. 8, 2000

Related U.S. Application Data
(63) Continuation of application No. 09/335,868, filed on Jun. 17, 1999, now abandoned.
Application No. 09/335,868 is a continuation-in-part of application No. 09/158,756, filed on Sep. 23, 1998, now abandoned.

(51) Int. Cl. B65G 59/02

(52) U.S. Cl. 414/796.7; 414/796.9

(57) ABSTRACT

A system for the automated storing or dispensing of one or more stacks of stackable goods is provided. The system comprises at least one pick-up site at which one or more stacks of stackable goods may be stationed, and at least one delivery site at which one or more stacks of stackable goods may be stationed. The system also includes a robotic pick-up means for securing and releasing one of the stackable goods, and movement means for moving the pick-up means into position to retrieve or deposit one of the stackable goods at a desired pick-up or delivery site. A control system is provided which can activate the pick-up means and the movement means, and is programmed to be operable to systematically move the stacks of stackable goods between the one or more pick-up sites and the one or more delivery sites.

This application is a continuation-in-part of application Ser. No. 09/158,756, filed Sep. 23, 1998.

### FIELD OF THE INVENTION

This invention relates generally to a system which automates the process of creating or dispensing an assembly of stackable goods.

### BACKGROUND OF THE INVENTION

It is convenient and cost-effective to purchase and transport many types of goods in bulk. Consequently, many products on the market are sold packaged in large bundles consisting of units stacked one atop another. Such goods are often stored on regularly sized pallets which use storage space efficiently.

However, where such an assembly of stackable goods is desired, labor is required to stack and unstack the goods. This labor can add much expense and inconvenience, especially where the goods are irregularly sized, are difficult or dangerous to handle, or can be contaminated by human handling. In some cases, the sheer volume of units of the goods to be processed is alone enough to make human packaging of the goods inefficient.

For example, pipette tips, which are used in large quantities in laboratory testing, are small items which are typically stored and transported in bulk in storage units such as racks. Pipette tip racks are difficult for humans to handle without risk of jarring the pipette tips out of the rack unless substantial support structures for the pipette tips are provided. Accordingly, processing large volumes of pipette tips, when using human labor, is highly time-intensive and expensive. Further, the cumbersome support structures needed to accommodate human handling of the tips adds bulk to pipette tip packaging and is environmentally undesirable. In many instances of laboratory testing using pipette tips, it is essential to avoid tip contamination by human handling. Lastly, it is also essential to avoid the risk of human contact with hazardous substances stored in pipette tips.

Accordingly, it is an object of the present invention to provide a system which automates the process of creating and/or dispensing assemblies of stackable goods, particularly loading and unloading pipette tip flats from an inventive cassette.

It is a further object of the present invention to provide a system for storing and dispensing pipette tips stored in flats without the need for human handling of the pipette tip flats.

Another object of the present invention is to provide a pipette tip cassette which stores pipette tips in a dense, precisely positioned array of tip flats and requires only minimal use of packaging materials. other objects and advantages of the current invention will become apparent when the inventive automated system for storing or dispensing stackable goods is considered in conjunction with the accompanying drawings, specification, and claims.

### SUMMARY OF THE INVENTION

A system for the automated storing or dispensing of one or more stacks of stackable goods is provided. The system comprises at least one pick-up site at which one or more stacks of stackable goods may be stationed, such that a stackable good may be retrieved from the top of each stack positioned at the pick-up site, and at least one delivery site at which one or more stacks of stackable goods may be stationed, such that a stackable good may be deposited upon the top of each stack positioned at the delivery site.

The system also includes a robotic device comprising pick-up means for securing and releasing one of the stackable goods, and movement means for moving the pick-up means into position to retrieve one of the stackable goods from the top of any stack stationed at any pick-up site, and for moving the pick-up means into position to deposit one of the stackable goods upon any stack stationed at any delivery site. A control system is provided which communicates with the robotic device such that the control system can activate the pick-up means and the movement means of the robotic device. The control system is programmed to be operable to systematically move the stacks of stackable goods between the one or more pick-up sites and the one or more delivery sites.

### BRIEF DESCRIPTION OF THE DRAWINGS

FIG. 1 is a side plan view of the inventive system wherein a cassette partially loaded with stacks of pipette tip flats is loaded into the robotic device.

FIG. 2 is a front plan view of the inventive system of FIG. 1 wherein the cassette is empty.

FIG. 3 is a top plan view of inventive system of FIG. 2.

FIG. 4 is a bottom cross-sectional view of the upper portion of the inventive system of FIG. 2 taken at section line 4-4 showing the configuration of the preferred pick-up controller.

FIG. 5 is a front plan view of the inventive cassette.

FIG. 6 is a side plan view of the inventive cassette.

FIG. 6A is a perspective view of an alternative cassette which may be used with the first or second embodiment of the inventive system.

FIG. 7 is a top plan view of the cassette shown mounted upon the elevator.

FIG. 8 is a perspective view of the pick-up unit delivering a pipette tip flat to a preferred tip depot.

FIG. 9 is a schematic view of the device with its system control.

FIG. 10 is a top view of the tip depot showing the gripper legs above.

FIG. 11 is a front view of the gripper of the pick-up unit depositing a flat upon the tip depot, with the tip depot partially cut away on the left side to show the placement of its interior components.

FIG. 12 is a side view of the gripper of the pick-up unit depositing a flat upon the tip depot, with the tip depot partially cut away on the left side to show the placement of its interior components.

FIG. 13 is a sequential flow chart of the operation of the inventive system's mode management.

FIG. 14 is a sequential flow chart of the operation of the inventive system when in manual operation mode.

FIG. 15 is a sequential flow chart of the operation of the inventive system when loading the cassette.

FIG. 16 is a sequential flow chart of the operation of the inventive system when in automatic operation mode.

FIG. 17 is a sequential flow chart of the operation of an alarm system of the inventive system.

FIG. 18 is a perspective view of a second embodiment of the inventive system in which stackable goods are delivered to or picked up from one or more passive cassettes.

FIG. 19 is a bottom plan view of a passive cassette of the second embodiment shown in FIG. 18.

FIG. 20 is a side elevation view of the second embodiment shown in FIG. 18.

FIG. 20A is a side cross-sectional view of a rotator assembly used in the second embodiment shown in FIG. 18.

FIG. 21 is a top plan view of the second embodiment shown in FIG. 18.

FIG. 22 is a schematic view of the device used in the second embodiment shown in FIG. 18 with its system control.

FIG. 23 is a sequential flow chart of the operation of control system of the second embodiment shown in FIG. 18 when in manual operation mode.

FIG. 24 is the first portion of a sequential flow chart of the operation of the control system of the second embodiment shown in FIG. 18 when in automatic operation mode.

FIG. 25 is a continuation of the sequential flow chart of FIG. 24.

### DESCRIPTION OF THE PREFERRED EMBODIMENTS

The inventive system is designed to automate the process of transporting stacks of stackable goods between locations. For purposes of this application, the term “stack” is used to refer to any number of stackable goods positioned in a linear progression with respect to one another. The “height” of a stack equals the number of stackable goods in the stack. For example, a single stackable good constitutes a stack of height one. Accordingly, a stack can constitute only one good. For convenience, the term “top” of the stack is used to describe an end of the stack to which stackable goods may be added or from which stackable goods may be retrieved. While the use of the term “top” suggests that the stack is vertically oriented, it should be understood that the stack can be oriented in any direction. For example, a stack could be oriented along a horizontal axis with the “top” of the stack constituting the rightmost end of the stack; it could be oriented along a vertical axis with the lowermost end of the stack constituting the “top” of the stack; or it could be oriented diagonally (with respect to the force of gravity) with one of the diagonally facing ends of the stack constituting the “top” of the stack.

The inventive system is described in particular with regard to two system embodiments. Each embodiment comprises a robotic device which includes a mobile pick-up unit operable to secure or release a stackable good, and movement means for moving the pick-up unit between one or more pick-up sites and one or more delivery sites, such that at any site, the pick-up unit may be operated to retrieve stackable goods from or deposit stackable goods to one or more stacks of stackable goods stationed at the site. It should be understood that this includes delivery of a single stackable good to a site at which no stackable goods are yet positioned, as that stackable good may be considered to have been deposited upon an “empty” stack stationed at the site.

Both described embodiments of the inventive system include one or more cassettes each of which serves as a either a pick-up site or a delivery site (or both, successively). The primary function of the cassettes used with both embodiments is to hold each stack of stackable goods processed by the inventive system in a defined position during active operation of the inventive system so that stackable goods may be deposited upon or retrieved from the stack using the pick-up unit. However, it should be understood that the inventive system may be used without a cassette or cassettes as long as the stackable goods being processed by the inventive system can be maintained in a stack in a defined position without the support of a cassette. For example, empty pipette tip flats, microplates, and microplate lids are typically rectangular goods which are substantially flat. Pipette tip flats, microplates, and microplate lids may all be stacked vertically and processed by the inventive system without the use of a cassette.

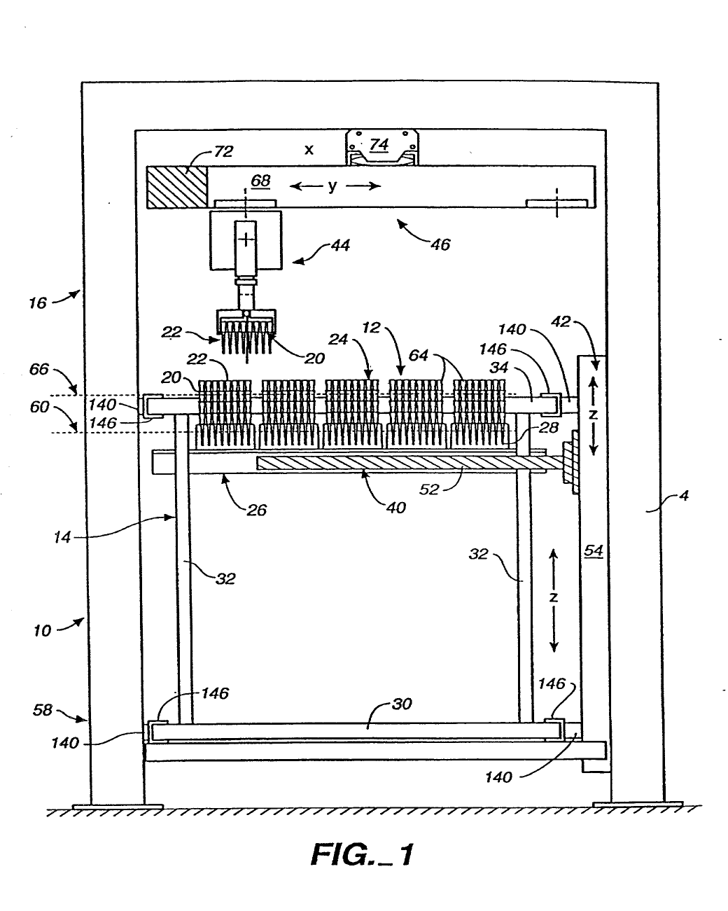

In the two described embodiments of the inventive system, it is further assumed that the units of stackable goods processed by the inventive system are pipette tip flats 20, as illustrated in FIGS. 1, 2, 5, 6, 8, 18, and 20. The flats 20 shown in those Figures house 96 pipette tips in an 8×12 array. However, it should be understood that pipette tip flats processed by the inventive system could house any number of pipette tips of any size in any spatial configuration. More broadly, the inventive system 10 can be used to process any stackable goods which can be retrieved from and deposited upon a stack by a robotic pick-up device. Such goods include, but are not limited to, flats of pipette tips, microplates, and microplate lids.

A. First Embodiment of System for Storing and/or Dispensing Stackable Goods

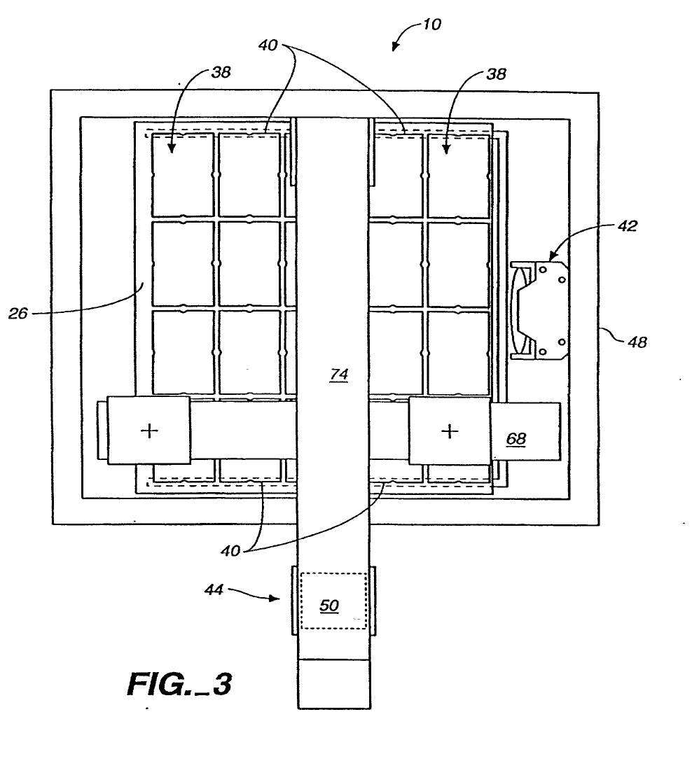

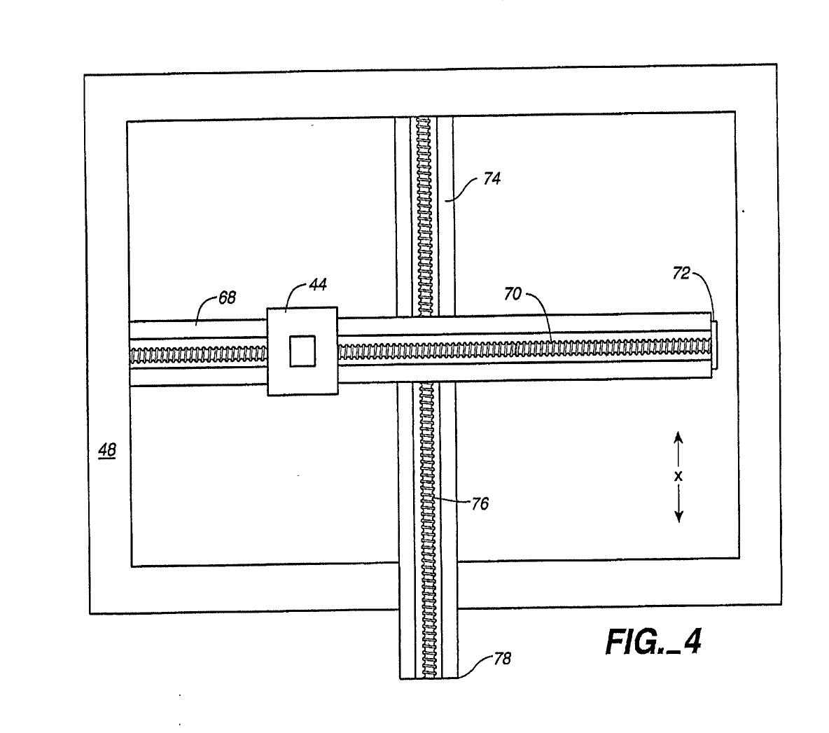

Referring to FIGS. 1, 2, 3, and 4, a first embodiment of the inventive system 10 for storing and/or dispensing stackable goods is shown. The first embodiment of inventive system 10 comprises a cassette 14 which houses an array of units 12 of stackable goods, a robotic device 16 designed to retrieve, transport, and release the stackable goods and to manipulate cassette 14, and a control system 18 programmed to operate the robotic device 16 to load units of stackable goods into or dispense units of stackable goods from cassette 14.

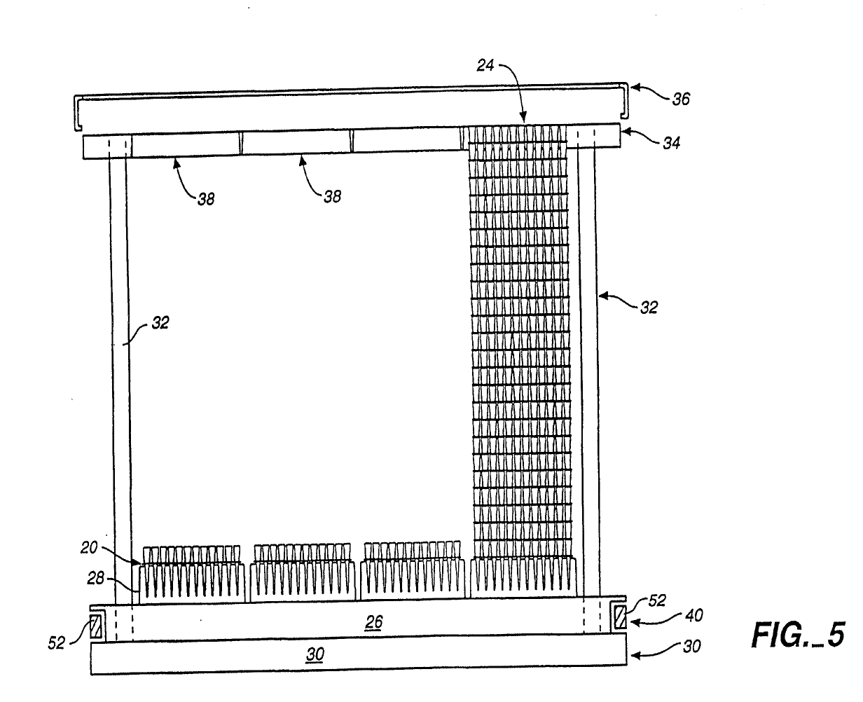

The first embodiment may be used to process vertically stacked flats 20 of pipette tips 22. FIG. 5 depicts such a stacked assembly 24 of pipette tip flats 20, with the pipette tips 22 of one flat 20 registering with and nesting within the pipette tips 22 in the flat 20 below. It should be understood that alternative methods of vertically stacking pipette tip flats may be used, including but not limited to fitting the lower portions of the pipette tips of one flat into the apertures formed between the pipette tips in the flat below.

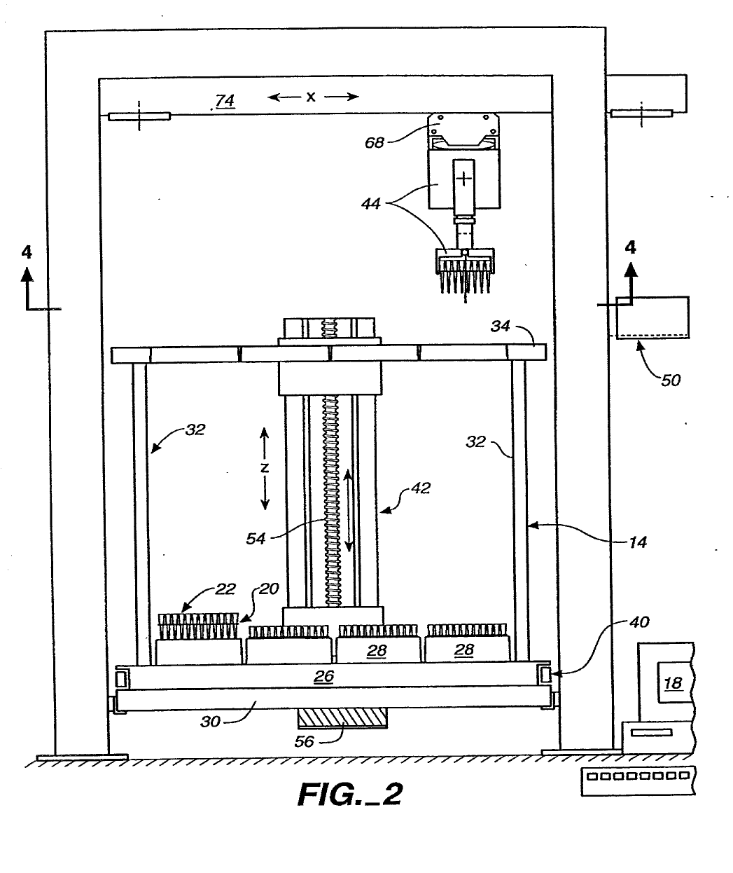

Referring to FIGS. 1 and 2, a preferred “active” cassette 14 used in the first embodiment has an elevator platform 26 upon which stacks 64 of pipette tip flats 20 may be placed into precisely defined positions, allowing robotic device 16 to add or remove flats from any stack 64 on elevator platform 26 as will be described below. Cassette 14 is termed an “active” cassette because a component of the cassette, elevator platform 26, is vertically mobile during operation of the system. When used with pipette tip flats 20, elevator platform 26 comprises flat depots 28 on its upper surface which are specially designed to receive the lowest flat 20 in each stack 64. The pipette tips 22 in the lowest pipette tip flat 20 in the stack 64 register with and fit into holes in the flat depot 28, such that the pipette tips 22 are maintained above the surface of elevator platform 26 and do not become contaminated. The flat depots 28 can be designed to accommodate varying lengths and configurations of pipette tips 22. It should be understood that if the inventive system is used to process other types of stackable goods other structures akin to flat depots 28 may be used.

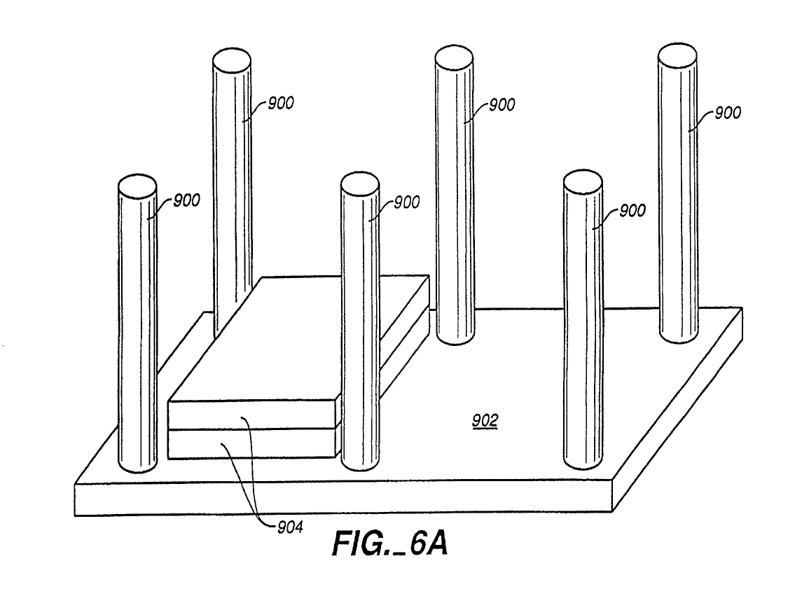

Referring to FIGS. 5, 6, and 7, in the first embodiment, cassette 14 further comprises a base 30, elevator guide rods 32, an index 34, and a lid 36. Elevator guide rods 32 are fixed to base 30, and elevator platform 26 is movably fitted upon guide rods 32. Index 34 is used to maintain each stack 64 of pipette tip flats 20 in a precise position as flats 20 are added to or removed from the stack 64 by robotic device 16, and is removably fixed to guide rods 32. Index 34 forms a set of openings 38 which register with the stacks 64 such that the top flat 20 on each stack 64 just fits through each opening 38. The flat depots 28 on elevator platform 26 align the stacks with openings 38 of index 34. Lid 36 can be fitted over index 34 to protect the cassette 14 and lock the stacks 64 of flats 20 stored in the cassette 14 into place.

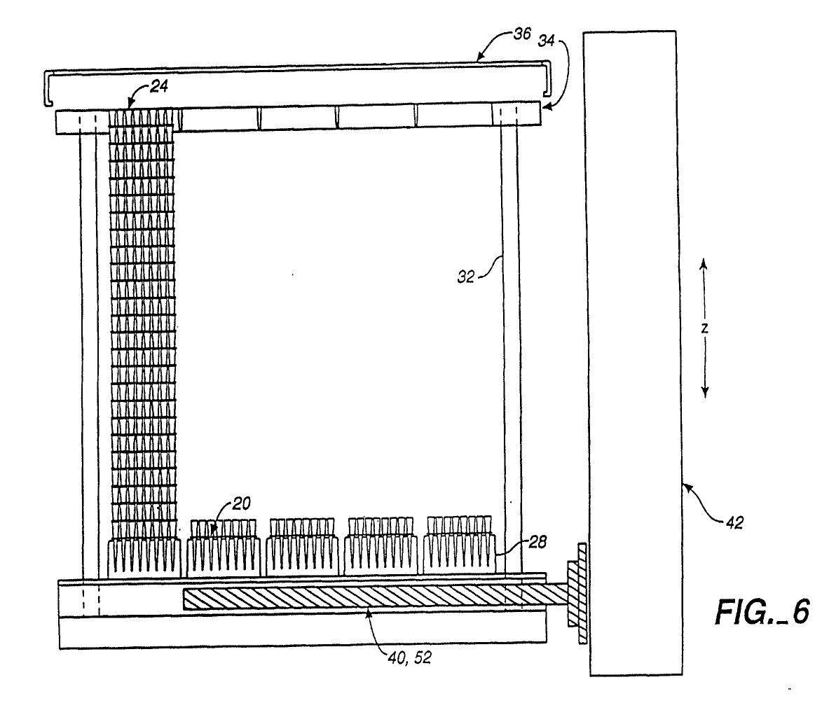

Index 34 is preferably made removable from guide rods 32 so that cassette 14 can be reloaded with prepackaged stacks of new pipette tip flats 20. For example, prepackaged refills of pipette tip flats having four 25-flat high stacks 64 (as shown in FIGS. 5 and 6) are available in the industry. In the preferred cassette 14, the elevator platform 26 comprises a four by five array of flat depots 28. To reload the cassette 14 with new pipette tip flats, the index 34 is removed, five prepackaged refills of flats 20 are fitted atop each four-length row of flat depots 28 to fully reload the cassette 14, and the packaging for the refills is pulled free. The index is then replaced and the cassette 14 is ready for unloading. It should also be noted that cassette 14 can also be reloaded with pipette tip flats 20 by individually loading pipette tip flats 20 into the cassette using the inventive system.

Cassette 14 is particularly suitable for transporting stacks 64 of flats 20 to and from locations where they will be processed. Additional structures may be added to cassette 14 as desired to enhance its transportability as long as these structures do not interfere with the actions of robotic device 16. For example, wheels could be mounted to the underside of base 30, if desired. Because the stacks 64 of flats 20 are fixed in place by index 14 and processed by robotic device 16 without the need for human handling, the amount of packaging needed to enclose the stacks can be minimized. Flats, rather than racks, are used to transport the pipette tips 22. Large numbers of pipette tip flats 20 may be packaged together in the relatively small cassette 14. The inventive cassette 14 has been used to house 20 stacks of 25 pipette tip flats each holding 96 pipette tips, allowing 48,000 pipette tips to be transported in one stable package.

Once the stacks 64 of pipette tip flats 20 are loaded into the cassette 14 and registered with the index 34, and the lid 36 is fitted over index 34, the cassette can be enclosed within protective packaging, such as a sealed poly bag and a shipment unit, if desired, and shipped by the manufacturer. Upon receipt, the customer removes the protective packaging, removes lid 36, and installs the cassette 14 into the robotic device 16.

It should be understood that many alternative embodiments of the cassette may be used with the first embodiment (or in the inventive system generally). The term “cassette” is used to generally encompass any structure which is used to hold one or more stacks of the stackable goods processed by the system securely in a defined position so that the robotic device may pick up stackable goods from or deposit stackable goods upon the top of each stack. Accordingly, a “cassette” includes, but is not limited to, the preferred cassette 14 described here in relation to the first embodiment; an isolated flat depot for holding pipette tip flats (such as any independent flat depot 28), or a simple structure such as that shown in FIG. 6A, comprising a set of upright posts 900 set into a base 902 in a pattern such that groupings of the posts 900 (such as the rectangular post groupings shown in FIG. 6A) align stackable goods of the desired size (such as rectangular lids 904) in stacks between the posts 900.

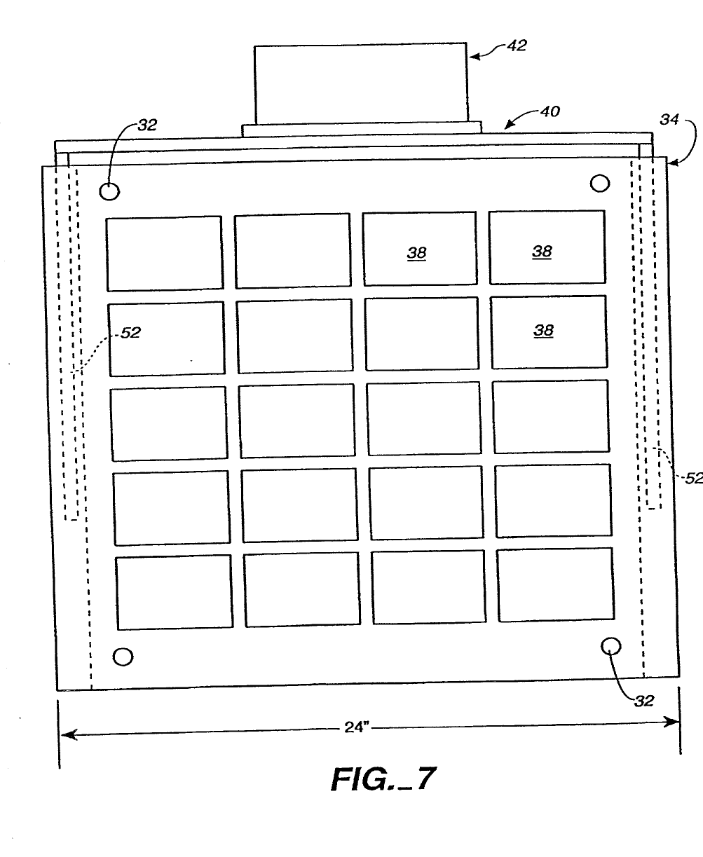

Referring to FIGS. 1, 2 and 3, robotic device 16 comprises elevator platform engaging forks 40; an elevator 42 for controllably raising and lowering elevator platform engaging forks 40, thereby raising or lowering elevator platform 26; a mobile pick-up unit 44 mounted above elevator platform engaging forks 40 for securing and moving individual flats 20 from stacks 64; and a pick-up unit controller 46 operable to move the mobile pick-up unit 44 laterally and longitudinally. These elements are mounted within a single housing 48. Robotic device 16 is operated by control system 18 to deliver flats 20 to or retrieve flats 20 from a delivery site 50 (see FIG. 8), which will typically be a loading station of another robotic device as will be described in more detail below, but which can be a fixed location such as a loading dock. It should be understood that while the first embodiment is described as including only one delivery site 50, more than one delivery site 50 may be used.

When cassette 14 is inserted into robotic device 16, elevator platform engaging forks 40 engage with and support elevator platform 26. In the first embodiment, elevator platform engaging forks 40 comprise two laterally disposed forklift arms 52. Elevator platform 26 is hollowed such that it forms laterally extending openings into which forklift arms 52 may be fitted when cassette 14 is inserted into robotic device 16. Cassette 14 itself can be supported within robotic device 16 by various means. A preferred means used to support cassette 14 when manually loaded comprises two slide-out drawer supports mounted upon housing 48. These drawer supports engage the underside of the base 30 of cassette 14 on opposing sides. Alternatives to manual loading of cassette 14 include, but are not limited to, loading cassette 14 into robotic device 16 on a wheeled cart which rests on the floor of robotic device 16, or loading cassette 14 into robotic device 16 using a automatic conveyor system which would move cassette 14 into robotic device 16. Guides (not shown) projecting from the sides of housing 48 could then be used to align cassette 14 as desired within robotic device 16. Robotic device 16 may also be provided with a door (not shown) which may be closed once cassette 14 is loaded into robotic device 16 and which may assist in holding cassette 14 in place.

It should be understood that both disposable and non-disposable cassettes may used in the inventive system. Disposable cassettes, for example, may be loaded into the robotic device, filled with or emptied of stackable goods, removed from the robotic device, and discarded. Alternatively, a non-disposable cassette, for example, may be loaded into the robotic device, either emptied or filled once or used repeatedly as stackable goods are successively loaded and unloaded from the cassette, removed from the robotic device, and stored elsewhere for further later use. It should also be understood that the cassette may be fixed to the robotic device so that the cassette is not designed to be removed from the robotic device at all. Further, the robotic device could be designed to hold and operate more than one cassette simultaneously.

Elevator platform 26 of cassette 14 is supported by the elevator platform engaging forks 40 in a horizontal plane defining an X-axis and a Y-axis. Elevator 42 is operable to move elevator platform engaging forks 40 along a vertical Z-axis. The axes are thus labelled to facilitate the reader's understanding of the invention.

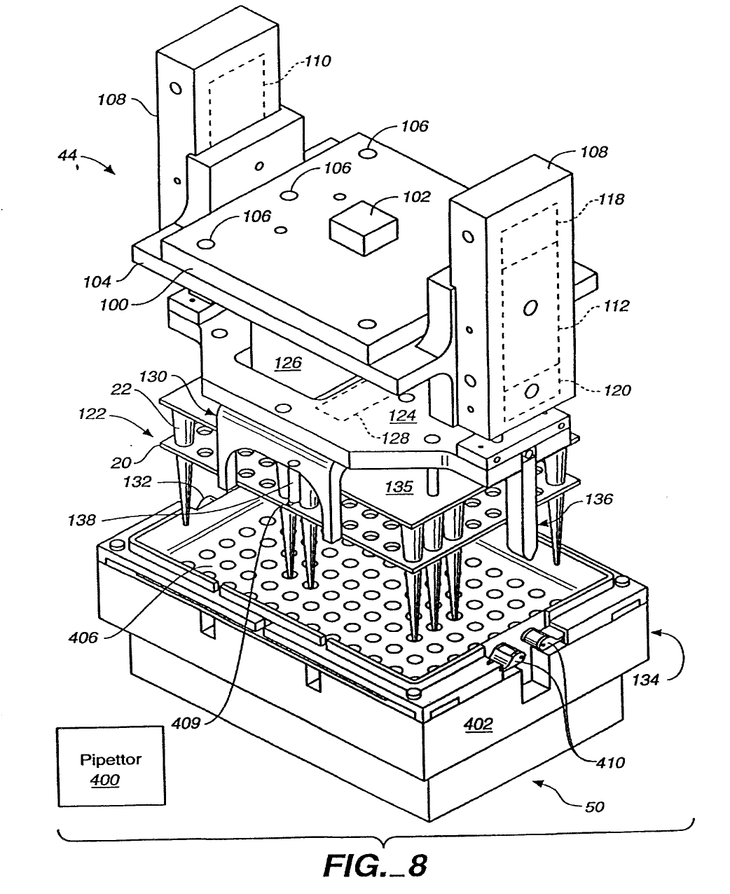

Elevator 42 can take a variety of forms. Referring to FIG. 2, a preferred embodiment of elevator 42 comprises a vertically disposed first jackscrew 54 and a first jackscrew control means such as a first servomotor 56. First jackscrew 54 can be fixed to housing 48. Elevator platform engaging forks 40 are connected to jackscrew 54 in a fashion such that elevator platform engaging forks 40 move vertically when jackscrew 54 is activated. First servomotor 56 is operable to activate first jackscrew 54 to lift or lower elevator platform engaging forks 40, and thereby elevator platform 26, over a range of positions from a low resting point 58 to a high resting point 60. As a safety feature, a brake 61 (see FIG. 9) is preferably provided which locks elevator platform engaging forks 40 into place after each activation of jackscrew 54. Brake 61 will prevent elevator platform 26 and its contents from falling and sustaining damage in the event of a malfunction.

It should be understood that an alternative cassette may be used with robotic device 16 wherein the cassette incorporates means operable by control system 18 for raising and lowering elevator platform 26. In that case, robotic device 16 would not require either elevator platform engaging forks 40 or elevator 42. Control system 18 would then signal the means for raising and lowering elevator platform 26 included in the cassette in order to raise the level of the top of stacks 64 to the desired height.

The mobile pick-up unit 44 can be operated as follows by pick-up unit controller 46: it can be lowered and secured about the uppermost unit of stackable goods of a stack 64 located on elevator platform 26 directly below pick-up unit 44 at a vertical height level 66; it can lift that unit vertically away from the stack 64; it can be moved laterally over cassette 14 into position above any stack 64 on elevator platform 26; and it can be moved into position at delivery site 50 for drop-off or pick-up of a unit 62. Pick-up unit 44 is mounted such that it does not strike cassette 14 when moving laterally.

Pick-up unit controller 46 preferably comprises the following components: a Y-axis drive housing 68 extending along the Y-axis above elevator platform engaging forks 40; a second jackscrew 70 laterally disposed within Y-axis drive housing 68 to which pick-up unit 44 is movably secured; a second servomotor 72 controlling second jackscrew 70; an X-axis drive housing 74 extending along the X-axis above the elevator platform engaging forks 40 and also to the delivery site 50; a third jackscrew 76 laterally disposed within X-axis drive housing 74 to which Y-axis drive housing 68 is movably secured; and a third servomotor 78 controlling third jackscrew 76. X-axis drive housing 74 is fixed to housing 48.

Preferably control system 18 communicates with servomotors 56, 72, and 78 by signals such that control system 18 directly controls the movements of elevator platform engaging forks 40 and pick-up unit 44. However, it would also be possible to use separate intermediate control units which would directly control one or more of the servomotors and would themselves be activated by control system 18. Alone or in conjunction with such intermediate control units, the control system 18 can activate first servomotor 56 to rotate first jackscrew 54 to vertically move elevator platform 26; activate second servomotor 72 to rotate second jackscrew 70 such that pick-up unit 44 can be moved along Y-axis drive housing 68 to any position on the Y axis above elevator platform 26; and activate third servomotor 78 to rotate third jackscrew 76 in order to move the Y-axis drive housing 68 along X-axis drive housing 74 to any position on the X axis above elevator platform 26 or to delivery site 50.

Referring to FIG. 8, a preferred embodiment of the pick-up unit 44 is shown which operates using air actuation. Plate 100 of pick-up unit 44 is movably secured to second jackscrew 70 by bolt 102. Plate 100 is fixed atop another plate 104 by a set of bolts 106. Plate 104 is disposed between two side walls 108 within each of which a vertical pneumatic cylinder 110 and 112 is disposed, such that either side of plate 104 is fixed to a pistons within each cylinder. Referring to FIG. 9, air is provided from an air source 114 through a pneumatic manifold 116 through air conduits (not shown) to each pneumatic cylinder 110 and 112. Pneumatic manifold 116 is operated by control system 18 to operate a set of valves which provide air pressure at appropriate times to the air conduits. By feeding air through the conduits to the pneumatic cylinders, upward or downward pressure is exerted on the piston of each cylinder 110 and 112, causing side walls 108 to be raised or lowered in relation to plate 104. Referring to FIG. 8, at least one of the pneumatic cylinders 112 preferably comprises two sensor units 118 and 120. Sensor 118 indicates when the piston of pneumatic cylinder 112 is in a fully raised position, and sensor 120 indicates when the piston of pneumatic cylinder 112 is in a fully lowered position. Pneumatic cylinders 110 and 112 are commercially available from SMC Pneumatics, Inc. of Indianapolis, Indiana.

The gripper 122 of pick-up unit 44 is disposed below plate 104 and side walls 108. Gripper plate 124 is fixed on either side to the bottom of each side wall 108. Gripper plate 124 preferably forms a central aperture through which a flat sensor 126 mounted underneath plate 104 extends. Flat sensor 126 is used to detect whether a flat 20 has been picked up by the gripper 122 beneath the sensor 126. A third pneumatic cylinder 128 is disposed within gripper plate 124 between the two longer sides of gripper plate 124. Two sets of two gripper legs 130 are also provided adjoining the centers of each of the longer sides of gripper plate 124, each fixed below gripper plate 124 to one of the pistons of pneumatic cylinder 128. Each gripper leg 130 has an inwardly extending dog 132 designed to engage the underside of a pipette tip flat 20.

It should be understood that the gripper 122 configuration employed in the pick-up unit 44 is designed to allow the pick-up unit for engaging pipette tip flats. Accordingly, when the inventive system is used to transport different stackable goods, it may be necessary to modify the gripper 122 to accommodate the characteristics of those goods.

Third pneumatic cylinder 128 is a normally open pneumatic actuator available from SMC Pneumatics, Inc., which when not actuated holds each set of gripper legs 130 in its open position. When actuated through manifold 116, third pneumatic cylinder 128 forces each set of gripper legs 130 to close. Thus, the gripper legs 130 can be opened to release a flat 20 and closed to secure a flat 20. A tip stabilizer spring-loaded plate 135 is mounted below gripper legs 130 which acts to hold the pipette tips 22 upon flat 20.

When used to deliver flats 20 to a preferred tip depot 134 at delivery site 50 (described in detail below), the following elements are also included. Two activator pins 136 are mounted extending downwardly from gripper plate 124, one fixed to the center of each short side of gripper plate 124. Two pylons 138 are mounted extending downwardly from gripper plate 124, one fixed between each set of two gripper legs 130. The functions of activator pins 136 and pylons 138 will be described below.

While the preferred embodiment of pick-up unit 44 utilizes air actuation, it should be understood that other means, including but not limited to servomotors, could be used to allow pick-up unit 44 to move vertically and to pick up and release flats 20.

The first embodiment of the inventive system is described assuming that an active cassette is used. However, the first embodiment could, alternatively, employ either one or more passive cassettes (such as one or more flat depots), or be used without a cassette. If so, the pick-up unit 44 should be made vertically mobile over a sufficiently large range that it can retrieve flats 20 from or deposit flats 20 to the lowest possible level for the top of each stack 64. For example, if a flat depot is used as a cassette, the control system 18 should be able to lower the pick-up unit 44 sufficiently to retrieve a the bottommost flat 20 stacked upon the flat depot.

Preferably, the inventive system also provides one or more locking devices which are operable by control system 18 to lock cassette 14 into place when inserted into robotic device 16. Referring to FIG. 1, in the first embodiment of the inventive system, four air clamps 140 are mounted on robotic device 16, two of which engage opposing sides of base 30 and two of which engage opposing sides of index 34. Each air clamp 140 comprises a pneumatic cylinder 142 (see FIG. 9) within which a piston 144 is disposed to which a lock 146 securable to base 30 or index 34 is connected. Referring to FIG. 9, air provided from air source 114 passes through a second pneumatic manifold 148 into air conduits extending to each air clamp 140. When locking, control system 18 signals second manifold 148 to allow air from air source 114 into the air conduits such that pistons 144 and, accordingly, locks 146 are pushed outward into engagement with cassette 14. When unlocking, control system 18 signals second manifold 148 to allow air from air source 114 into the air conduits such that pistons 144 and locks 146 are forced inward, releasing cassette 14.

The heart of control system 18 may be a microprocessor or computer. FIG. 9 shows a schematic of the preferred embodiment of the control system 18 in relation to the other circuitry of the inventive system. An industrial PC 150 receives its power from a power source 152 which may be conventional 110 volt house power. It should be understood that power source 152 would also be utilized for any power applications in the inventive system that may be operable through control system 18. PC 150 is preferably located nearby the robotic device 16 at an accessible station, but could be fixed to or incorporated within robotic device 16 if desired. PC 150 has input devices through which a human user can control the loading and unloading processes provided by the inventive system, including but not limited to a keyboard (not shown) and a touchscreen mounted atop housing 48. The industrial PC 150, the touchscreen, and their operating software (the SELwin system) are available commercially as a package from Total Control Products, Inc. of Melrose Park, Ill. The touchscreen is powered by power source 152. First, second, and third servomotors 56, 72, and 78 are directly controlled from the touchscreen, as well as brake 61 which locks elevator platform engaging forks 40.

Note that while the control system 18 for the first embodiment is described as controlling only one robotic device 16, the control system can be modified to operate more than one robotic device 16 (and, accordingly, to process more than one cassette 14 at the same time).

In the first embodiment of the inventive system control system 18 further comprises a cassette bar code reader 156 and a cellular modem 158. Cassette bar code reader 156 is used in conjunction with bar codes marked upon each cassette 14 which identify the characteristics of that cassette, including but not limited to how many flats 20 are on each level, how many levels of flats 20 are in the cassette, and the size of flats 20. Cellular modem 158 is primarily used to call and inform a master system run by the manufacturer of the cassettes 14 and/or the robotic device 16 when each cassette 14 indicated by a particular bar code is being processed. This can be used as part of an automatic reordering system for cassettes 14. Additionally, cellular modem 158 can be used to signal alarms to a remote location if control system 18 detects errors in functioning during processing.

The inventive system 10 preferably incorporates a sensor (not shown) which control system 18 can operate to determine the height difference between the levels of flats 20. This allows the inventive system to automatically adjust the movements of pick-up unit 44 and the raising and lowering of elevator platform engaging forks 40 appropriately to the height of each level of flats 20 in the particular cassette.

PC 150 utilizes an I/O termination block 160 which sorts and sends out signals as discrete inputs and outputs corresponding to various controls of the components of robotic device 16. Discrete outputs include, but are not limited to: an emergency stop signal, a ready signal, a run signal, a cycle complete signal, a signal to lock air clamps 140, and signals to raise, lower, and open gripper legs 130. Discrete inputs include, but are not limited to: an emergency stop signal generated from the robotic device 16; an emergency stop signal generated from a remote source such as through cellular modem 158 or from another controller with which PC 150 communicates; a pipettor ready signal indicating that a robotic pipettor (described below) which processes the flats of pipette tips is ready to deliver or receive flats 20; a signal indicating that the loading area of the pipettor is clear; signals from each air clamp 140 indicating successful closure; a signal from the air source 114 that air is available; and a signal that the door to robotic device 16 is open or closed. I/O device 160 controls manifold 116 which controls cylinders 110 and 112 used to raise and lower side walls 108 and cylinder 116 used to open and close gripper legs 130, and manifold 148 which controls cylinders 142 used to open and close air clamps 140.

Preferably inventive system 10 is adapted to receive flats 20 from or deliver flats 20 to a robotic pipettor 400 which processes the flats 20. Such robotic pipettors include, but are not limited to: 96 barrel pipettors such as the Cyclone pipettor available from Scitec, Inc. of Wilmington, Del., the MultiMek pipettor available from Carl Creative of Harbor City, or the Cyberlab 96 Well Pipetting Workstation from Cyberlab, Inc. of Brookfield, Conn.; and flexible pipettors (which pick up four to eight pipette tips from a flat 20 at a time) such as the Genesis pipettor available from Tecan or RTP, North Carolina; the Biomek 2000 pipettor available from Beckman of Fullerton, Calif., California; or the MultiPROBE pipettor available from Packard Instrument Co. of Meriden, Conn.

Delivery site 50 is then the location at which the robotic pipettor receives or delivers the flats. However, it should be understood that delivery site 50 can be any location at which the flats 20 are processed, such as a docking station from which the flats are moved by human effort or by a conveyor belt. For purposes of the described first embodiment, it is assumed that flats delivered to the delivery site are immediately processed, such that the pick-up unit delivers flats to or retrieves flats from the same location at the delivery site every time. However, the inventive system may, for example, be designed to stack or unstack flats at the delivery site.

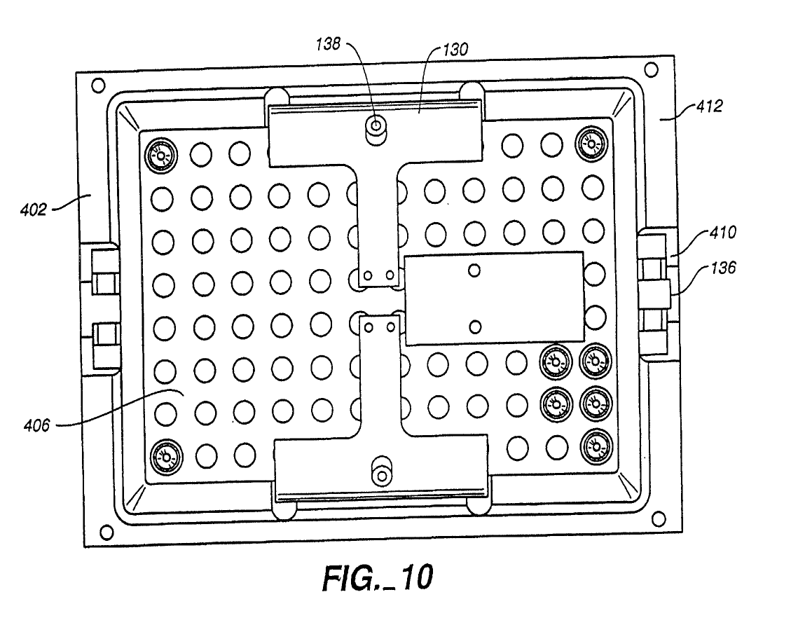

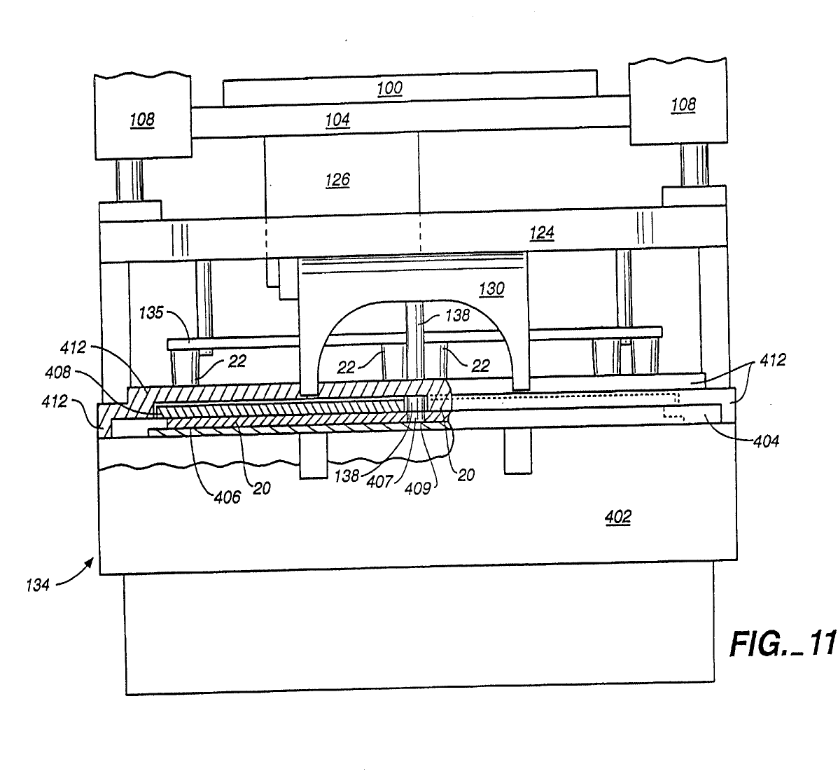

Referring to FIGS. 8 and 10-12, whether using a robotic pipettor or some other location such as a docking station, pipette tip flats 20 are preferably delivered to a special tip depot 134 designed to lock the flats 20 into place for further processing. Tip depot 134 comprises a receiver box 402 upon which a number of elements are mounted. A bottom ring 404 (see FIG. 11) is mounted atop receiver box 402 which forms an aperture within which an alignment grid 406 is disposed. Alignment grid 406 forms an equal number of holes corresponding to the holes in the type of flat 20 delivered to the tip depot 134, and is designed to receive a flat 20 atop it with the flat's pipette tips 22 extending through the holes in alignment grid 406. Preferably alignment grid 406 includes two upstanding hotels 407, one located at each center of the longer edges of the alignment grid 406. These hotels are designed to register with slots 409 formed in the center of each longer edge of the pipette tip flat 20 to hold the flat 20 in place on alignment grid 406. By holding the flat 20 in place and providing a undersurface for flat 20, alignment grid 406 will resist any downward force on the flat 20 exerted by a robotic pipettor 400 picking up or delivering tips 22 from or to flat 20.

Two capture blades 408 are mounted extending lengthwise across tip depot 134 atop bottom ring 404. Four pusher arms 410 are provided, two mounted near the center of each short side of the tip depot 134, each of which is attached to an inner corner of a capture blade 408. A top ring 412 is mounted to the bottom ring 404 at each corner, fitting over capture blades 408 and pusher arms 410. Four blade springs 414 are mounted to top ring 412 at each outer corner of the capture blades 408, which exert an inward force on capture blades 408. When blade springs 414 are in their relaxed state, capture blades 408 extend over alignment grid 406 sufficiently that a pipette tip flat 20 will not pass between capture blades 408.

Top ring 412 forms an aperture defined by a raised ridge. The raised ridge slopes inwardly on its inner edge to aid in guiding the pipette tip flat 20 onto alignment grid 406.

When a pipette tip flat 20 is delivered to the preferred tip depot 134, activator pins 136 engage pusher arms 410. The downward pressure of activator pins 136 cause the pusher arms 410 to exert outward horizontal pressure against capture blades 408, compressing blade springs 414 and moving capture blades 408 outward sufficiently to uncover all of alignment grid 406 and allow flat 20 to pass between them. Once gripper 122 is fully lowered, as indicated to control system 18 by sensor 120, control system 18 opens gripper legs 130, depositing flat 20 upon alignment grid 406. At the same time, pylons 138 exert a downward force upon slots 409, pushing slots 409 onto hotels 407. Capture blades 408 remain open during this process. Control system then raises gripper 122, causing activator pins 136 to disengage from pusher arms 410. Blade springs 414 then resume their relaxed state, pushing capture blades 408 over flat 20. The flat then rests on the tip depot 134 engaged upon hotels 407 through slots 409 and covered by capture blades 408.

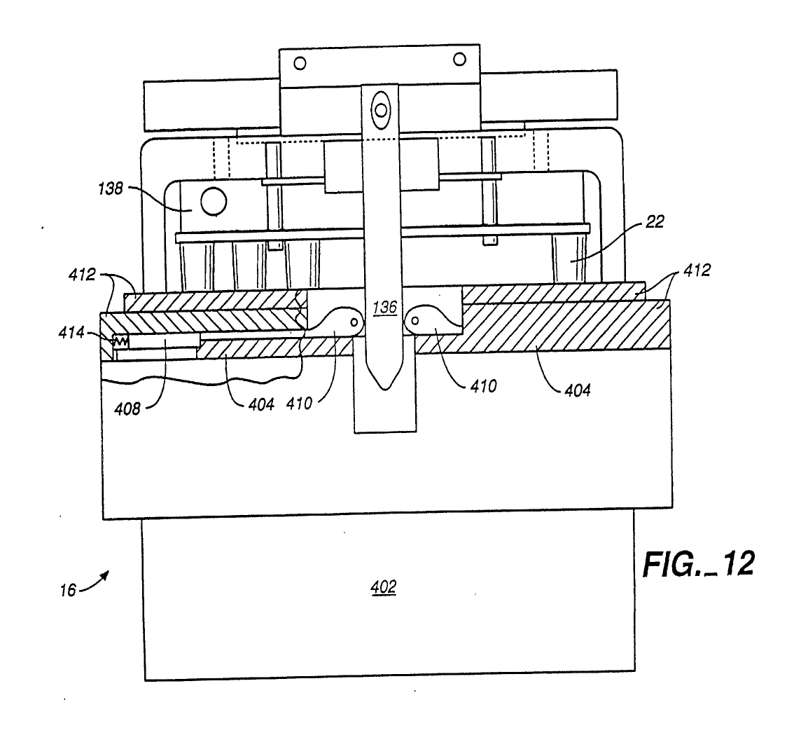

Control system 18 is programmed to load or unload cassette 14 according to the process steps described as follows. The first embodiment of the inventive system operates both in automatic or manual mode. Referring to FIG. 13, a progressive flowchart of the overall operation of the inventive system is shown. At operation block 200, the inventive system is activated by a human user. At decision block 202, the system remains on standby until it receives a signal indicating ready to run status from master permissive status block 204. This signal can be received from an outside source such as a robotic pipettor, to indicate that it is ready to deliver flats to or receive flats from the inventive system, or can be manually input. Once the run signal is received, at decision block 206 the control system 18 checks to see whether automated or manual status has been selected. If automated status is selected, at operation block 208 the manual task system is turned off and at decision block 210 the system checks whether the alarm management system is on. If not, the alarm management system is turned on at operation block 212. The automated task system is then started at operation block 214, and will be described in more detail below.

If manual status is selected, the automated task system is turned off at operation block 216 and the manual task system, described in more detail below, is started at operation block 218. At decision block 220, the control system 18 determines whether a cassette 14 has been loaded. If not, at operation block 222, a cassette loading task system is activated. At operation block 224, a timer is checked to determine whether control system 18 has been waiting in ready mode for an extended time period; if so, an alarm is triggered indicating the delay.

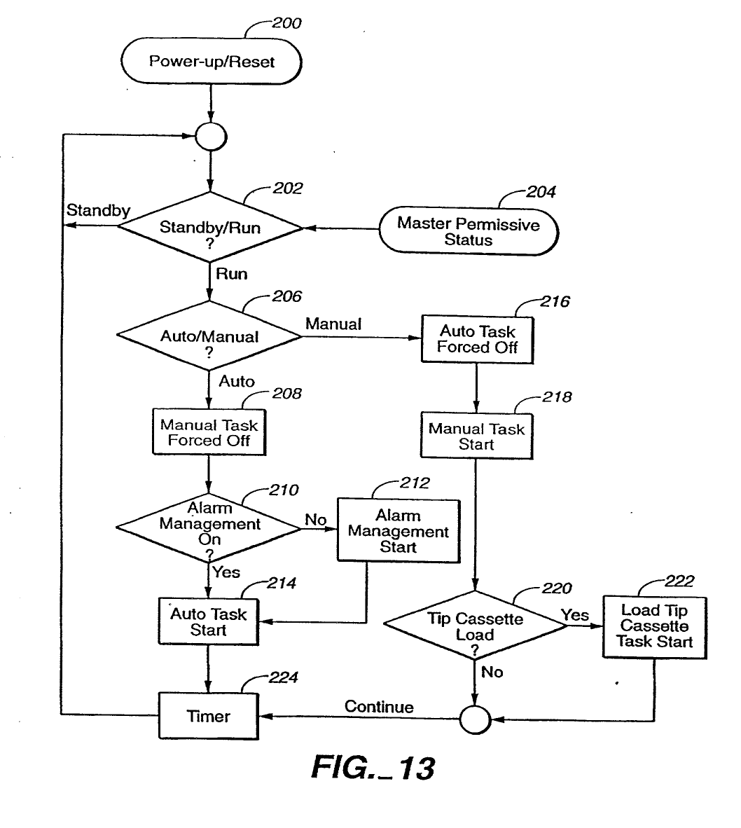

FIG. 14 is a sequential flowchart of the manual task system. While the manual task system is activated, control system 18 loops through a set of decision blocks corresponding to manual switches controlling movements of the X, Y, and Z axis: an X-axis switch forward 226, an X-axis switch backward 228, a Y-axis switch forward 230, a Y-axis switch backward 232, a Z-axis switch forward 234, and a Z-axis switch backward 236. At each of these decision blocks, if the manual switch is activated, the control system signals the jackscrew corresponding to that axis accordingly. Thus, if the X-axis switch forward is activated at decision block 226, at operation block 238 control system 18 causes jackscrew 76 to rotate in the direction defined as forward (which can be chosen as is convenient, as long as it is consistent). Operation blocks 240, 242, 244, 246, and 248 similarly correspond to decision blocks 228, 230, 232, 234, and 236, respectively.

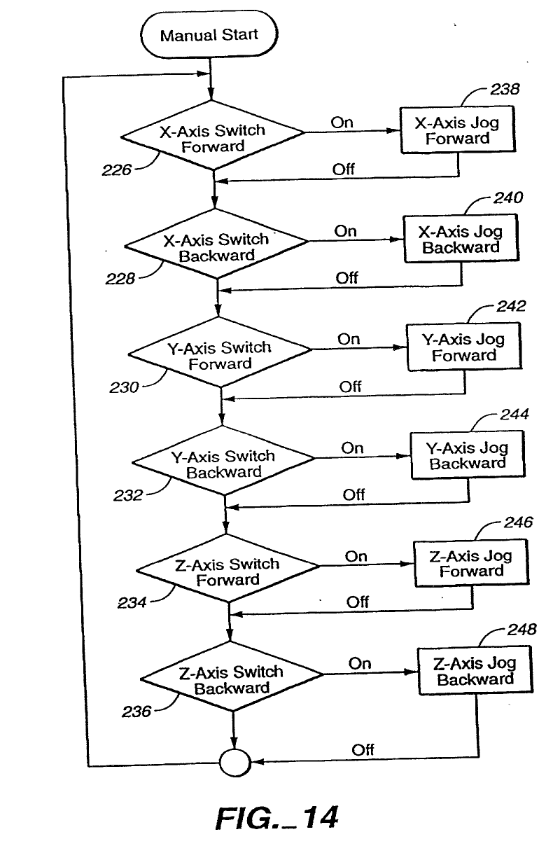

In the currently formulated embodiment of the inventive system, cassette 14 is loaded manually into robotic device 16. FIG. 15 is a sequential flow diagram of the manual cassette loading task. At operation block 250, the alarm management task to be described below is turned off so that alarms are not triggered during the loading process. At decision block 252, the control system 18 checks for a manual input signal to unlock air clamps 140. When the manual input signal is on, the control system 18 unlocks clamps 61 at operation block 254. The air clamps 61 remain unlocked until the manual input signal to decision block 252 is turned off. The control system 18 locks clamps 61 about the cassette 14 at operation block 256. The cassette locking process is manually confirmed at decision block 258. The control system 18 returns to the cassette unlocked decision block 252 and continues this process until the confirmation is manually input to control system 18. If the locking process is unsuccessful, then the control system 18 will alarm the condition when the alarm management task is restarted at operation block 260.

It should be understood, however, that an automated cassette delivery and loading system could be used instead to automatically load cassettes 14 into robotic device 16.

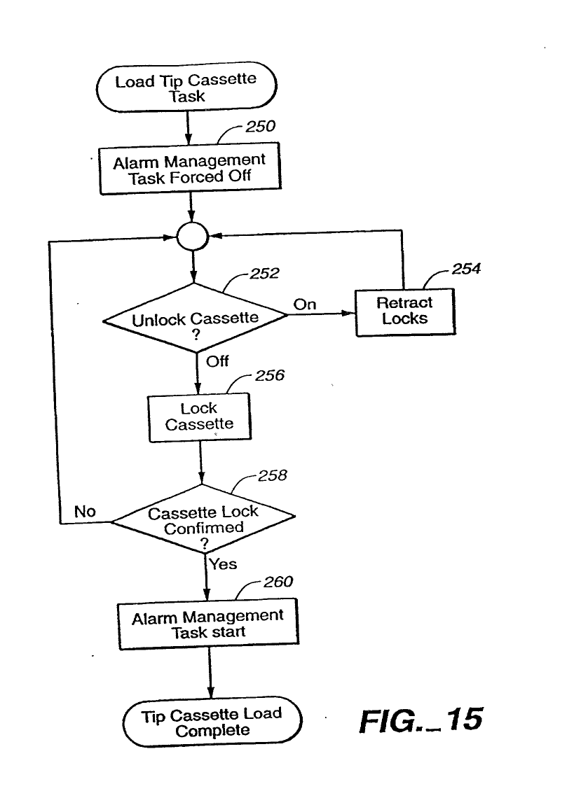

FIG. 16 shows the automated task system. At decision block 262, the control system 18 determines whether it is starting a new loading or unloading process, or is resuming an old loading or unloading process. If the process is new, at operation block 264 the program variables are initialized. Program variables include, but not limited to, the number of flats 20 per level, the number of levels of flats 20 per cassette 14, and the number of levels and flats of the cassette which have already been processed (initially zero). At decision block 266 the control system determines whether the cassette 14 is loaded into the robotic device 16. If not, at operation block 268 the control system 18 waits for manual mode and initiation of the manual loading task. It should be noted that if an automated cassette loading process is used operation block 268 could instead trigger an automated cassette loading task. Once control system 18 has determined that a cassette 14 is loaded into robotic device 16, it starts the cassette loading or unloading process.

At decision block 270, control system 18 determines whether the gripper 122 is raised. If not, at operation block 272 control system 18 raises the gripper 122. Once the gripper 122 is raised, the control system determines whether all of the levels of flats 20 have been processed at decision block 274. If they have been, the loading or unloading process is complete at block 276 and the control system 18 waits for manual mode to await insertion of another cassette 14 and resumption of the process. If not, the control system starts to load or unload the next level of flats 20 at operation block 278.

If the control system 18 determined at operation block 262 that the loading or unloading process to be undertaken is a resumption of an earlier started process, the control system 18 reinitializes the program variables to the values held when the process was suspended. The control system then proceeds to operation block 278 to resume loading or unloading of the upper level of flats 20.

At operation block 278, control system 278 elevates (for unloading) or lowers (for loading) the cassette until the top level of the stacks 64 on the cassette 14 are in position for pick-up or dropoff of flats 20 by pick-up unit 44, by activating first servomotor 56 to lift or lower elevator platform engaging forks 40 as appropriate. Control system 18 preferably determines the amount by which cassette 14 is elevated or lowered according to predetermined increments corresponding to the height of each level of flats 20 for the cassette 14 being processed. At operation block 280, the control system then activates the pick-up controller to move pick-up unit 44 into position above the current stack 64 from which a flat 20 will be taken or to which a flat 20 will be delivered. Control system 18 uses the program variables to determine the latitudinal and longitudinal position of the current stack 64 to be processed. To move pick-up unit 44, control system 18 activates the second jackscrew 70 to move the pick-up unit 44 along the X axis and activates the third jackscrew 76 to move the Y-axis drive housing 68 along the X axis into the proper position. Activation of jackscrews 70 and 76 may occur simultaneously or in succession in any order.

The control system then picks up or drops off a flat 20 from that stack 64. FIG. 16 shows the process for a cassette unloading process; the cassette loading process is conducted in similar fashion in approximately reverse order. At operation block 282, the gripper legs 130 are opened. Decision block 284 determines whether the legs 130 successfully opened fully. If not, operation block 282 is repeated. If so, the gripper 122 is lowered and the gripper legs 130 are closed at operation block 286. Decision block 288 determines whether the gripper legs 130 successfully closed fully. If not, operation block 286 is repeated. If so, a flat 20 has been secured in the gripper, and at operation block 290 the control system 18 activates the pick-up unit controller 46 to move pick-up unit 44 to the delivery site 50. Assuming the flats 20 are delivered to a robotic pipettor 400 at delivery site 50, at decision block 292 the system control 18 determines whether it has received a ready signal for delivery of a flat from the robotic pipettor 400. If not, operation block 290 is repeated. If so, the flat 20 is delivered by pick-up unit 44 to the tip depot 134 of the pipettor 400 at operation block 294, and at operation block 296 the control system 18 updates the program variables to reflect that the flat 20 from the current stack 64 has been processed.

At decision block 298, the system control then checks to see if all of the flats 20 on the current level of cassette 14 have been processed. If not, at operation block 300 the gripper 122 is raised and more flats 20 are processed for the level restarting at operation block 280. If the level has been fully processed, the program variables are updated at operation block 302 to reflect that the level has been completed, and processing the next level is restarted at decision block 270.

The inventive system preferably incorporates a number of alarms which warn the user of the system of undesirable conditions in the equipment. Preferably, alarms are provided which indicate that (1) there is low air pressure in the air source 114, (2) the door to the robotic device 16 is open, (3) there is a malfunction in the opening and/or closing of the gripper legs 130, (4) the gripper is not picking up flats 20, (5) the gripper is not raising properly, (6) the gripper is not lowering properly, (7) there is a communications failure indicated by the passage of too much time between processes, (8) the cassette tray is empty, (9) any air clamp 140 failed to lock, and (10) the cassette level failed to clear.

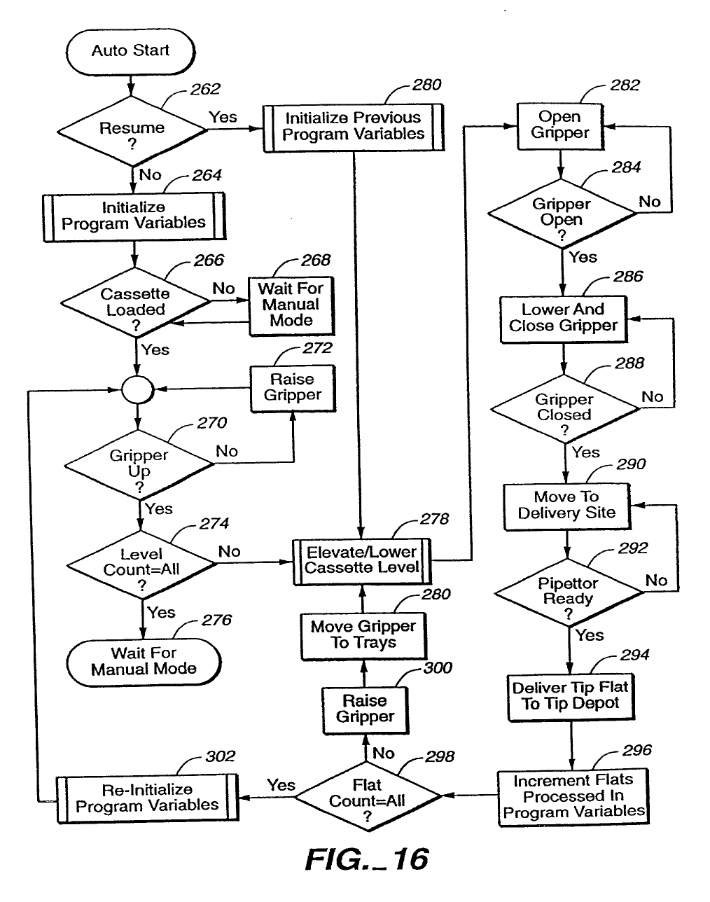

FIG. 17 shows the general process by which the control system 18 handles alarms. At operation block 310, the input data is scanned to see if alarms are indicated. At decision block 312, if alarms are present, the alarms are annunciated at operation block 314. Otherwise, the system returns to scan mode. If alarms are annunciated, control system 18 routes the alarm status by decision block 316 to the master permissive status. The master permissive status, whether on or off, is returned to the previously described mode management task shown in FIG. 15. the system determines at decision block 316 whether it is waiting to receive a ready to run signal from the master permissive status block. If so, it waits in master permissive status. If not, at decision block 318 the control system 18 checks its variables to determine whether the alarm is newly present. If not, the system returns to scan mode at operation block 310. If so, at decision block 320 the control system determines whether a horn is active for that alarm. If not, the horn is activated at decision block 322. The control system 18 then proceeds to check, at decision block 324, whether the alarm has been acknowledged by the user. If so, the horn for that alarm is deactivated at operation block 326. If not, the system returns to scan mode at operation block 310.

Users of pipette tips can avoid contamination problems with pipette tips by using two of the inventive systems 10. A first unit incorporating the inventive system may be used to unload fresh cassettes 14 of flats 20 of pipette tips 22 delivered by the manufacturer. After use, the used flats 20 may be loaded into a second cassette 14 and sterilized for further use or returned to the manufacturer. Because the equipment used to unload cassettes of new pipette tip flats 20 is separate from the loading equipment, no danger of contamination of the new pipette tip racks is presented.

B. Second, Alternative Embodiment of System for Storing and/or Dispensing Stackable Goods

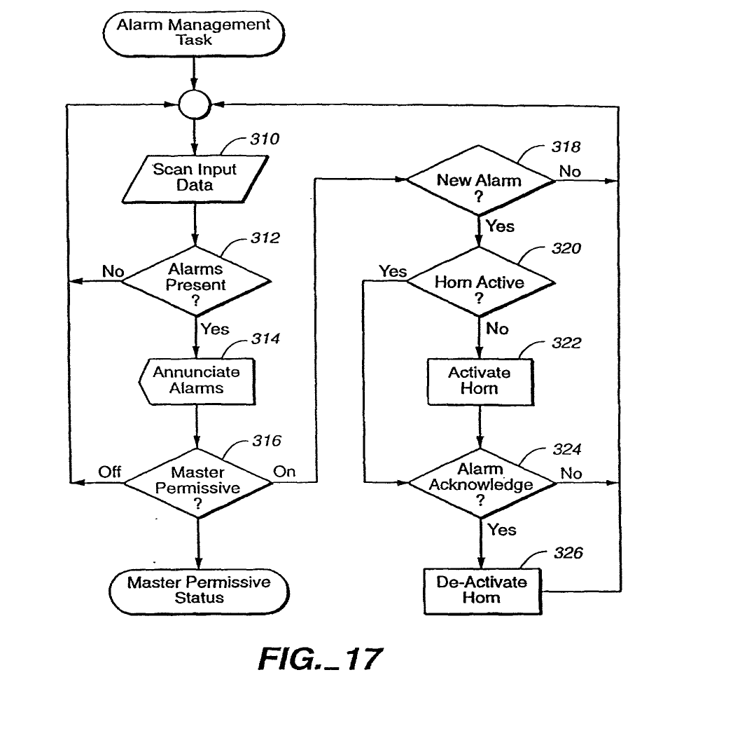

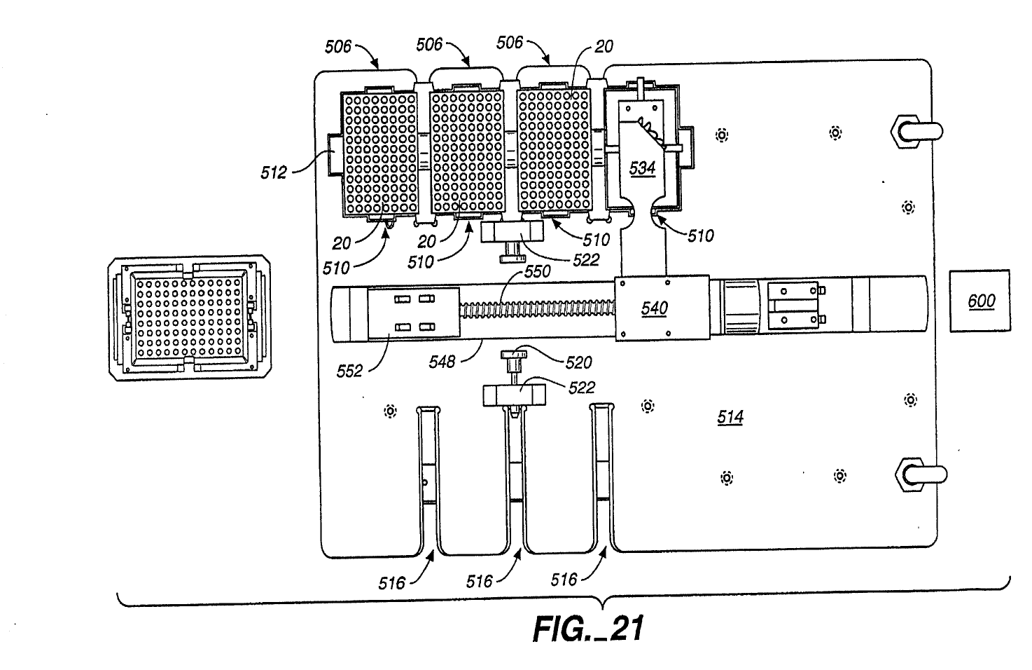

A second embodiment 500 of the inventive system for storing and/or dispensing stackable goods is shown in FIGS. 18, 20, and 21. This embodiment moves pipette tip flats 20 (or other stackable goods) between one or more “passive” cassettes 502 and one or more delivery sites (each of which could, for example, constitute either a tip depot such as tip depot 134 described above in relation to the first embodiment, or a passive cassette 502). Cassettes 502 are termed “passive” because they do not incorporate parts which move during operation of the inventive system. Passive cassettes 502 are designed to accommodate four stacks 504 of 20 pipette tip flats 20 arranged in a single column. It should be understood, however, that the passive cassettes 502 could be designed to accommodate larger or smaller stacks 504, or to store more or less than four stacks 504 in the column. The system shown in FIG. 18 is designed to use two passive cassettes 502, one shown, and one to be installed in the right hand side of loading floor 514.

Passive cassette 502 includes four bays 506, each of which houses one stack 504 of pipette tip flats 20. Bays 506 are essentially rectangular and are preferably sized such that pipette tip flats 20 may be securely fitted into bays 506 at close tolerances. Each bay 506 has a flat depot 28, as described above with regard to the first embodiment (see FIGS. 1, 2, and 6), fitted upon its floor, which is specially designed to receive the lowest pipette tip flat 20 in the stack 504 housed in the bay 506. In the second embodiment, each wall 508 of each of the four bays 506 incorporates an aperture 510 or concavity 512 along its central vertical axis to accommodate the entry of structures extending from a robotic pick-up device, described in detail below, used to pick up pipette tip flats 20 from each bay 506. No index, elevator, or lid is required for the passive cassettes 502.

Cassettes 502 may be sterilized, enclosed in a shrink film (not shown), and placed into a returnable shipping container (not shown) for shipment to customers. Once cassettes 502 arrive at the end user's site, an operator may remove the shipping container cover, remove the wrapped cassettes 502 from the container, and set the container aside. The operator may then remove the shrink film to gain access to the cassettes 502, and may then load the individual cassettes into the automated system.

Although the second embodiment is described as using a particular passive cassette 502, the second embodiment could use any type of passive cassette, active cassette, or no cassette. As described with relation to the first embodiment, the term “cassette” should be read to include any structure which is used to hold one or more stacks of the stackable goods processed by the system securely in a defined position so that the robotic device may pick up stackable goods from or deposit stackable goods upon the top of each stack.

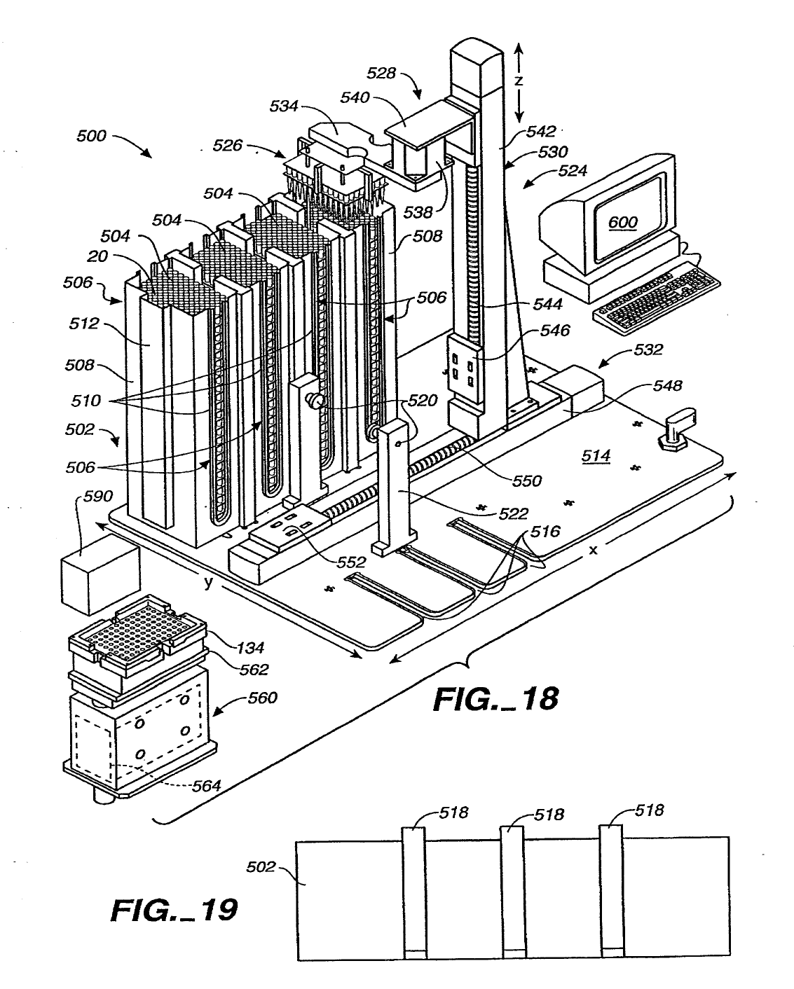

During the automated storage and/or delivery of the pipette tip flats, each passive cassette 502 should be locked into a fixed position. A loading floor 514 may be provided onto which one or more passive cassettes 502 may be fitted. While loading floor 514 is designed to hold two cassettes 502, a loading floor may be used which accommodates the use of more than two cassettes. Loading floor 514 has grooves 516 into which corresponding projections 518 formed on the undersurface of each passive cassette 502 (see FIG. 19) may be slidably engaged. A ball or pin detent 520 is also provided which may be operated to lock the cassette 502 to a locking station 522.

In the automated system shown in FIG. 18, two filled cassettes 502 may be fitted into loading floor 514 for unloading, or two emptied cassettes 502 may be fitted into loading floor 514 for loading. As another alternative, one filled cassette 502 may be fitted into one side of loading floor 514 for processing of flats 20 and an empty cassette 502 may be fitted into the other side of loading floor 514, so that flats 20 emptied after processing may be reloaded into empty cassette 502.

Robotic device 524 is provided which retrieves or delivers pipette tip flats 20 to or from passive cassettes 502. Robotic device 524 comprises a mobile pick-up unit 526, a rotator assembly 528, a Z-axis lifter 530, an X-axis driver 532, each of which is controlled by one or more controller units which may be separate, but are preferably incorporated into a control system 600 described in detail below. Mobile pick-up unit 526 is rotatably secured to rotator assembly 528, such that the mobile pick-up unit 526 can be rotated through an arc in a plane defined by the X and Y axes. The rotator assembly 528 is in turn movably secured to Z-axis lifter 530, such that the combined pick-up unit 526 and rotator assembly 528 can be raised or lowered along the Z-axis by Z-axis lifter 530. Z-axis lifter 530 is movably secured to X-axis driver 532 such that the entire rotatable, vertically mobile pick-up assembly can be moved forward or backward along the X axis.

Note that if the second embodiment is used with an active cassette which can be operated to lift the stackable goods stored in the active cassette, the Z-axis lifter may cover a smaller vertical range, as it would not be necessary to lower the pick-up unit 526 and rotator assembly 528 below a defined height level (such as height level 66 described in relation to the first embodiment and shown in FIG. 1).

The rotator assembly 528 of the second embodiment is designed to rotate the mobile pick-up unit 526 through at least 180 degrees to accommodate the configuration shown in FIG. 18, wherein two cassettes 502 are positioned to either side of the X-axis driver such that the pick-up unit 526 must rotate 180 degrees between depositing or retrieving flats 20 from one cassette 502 and depositing or retrieving flats 20 from the other cassette 502. However, it should be understood that the rotator assembly 528 may be designed to restrict the rotation of the mobile pick-up unit 526 by any amount, as long as the pick-up unit 526 may be rotated between every pick-up site (such as one of the cassettes 502) and every delivery site (such as tip depot 134) and those sites are spaced sufficiently apart from each other that stackable goods may be freely retrieved from or deposited to each site by the pick-up unit.

The inventive system may be designed to rotate the pick-up unit around any axis (for example, through a vertical or diagonal plane), or along more than one axis. Accordingly, while the second embodiment is designed to move stacked stackable goods vertically away from the stack and to rotate the pick-up unit 526 horizontally between the cassettes 502 and the tip depot 134, the inventive system, for example, could alternatively use a pick-up device which can be operated to secure a stackable good from a horizontally-oriented stack, move laterally to shift the stackable good away from the top of the stack, and rotate vertically to deliver the stackable good to a delivery site.

Because the pick-up unit 526 of the second embodiment 500 is already vertically mobile using Z-axis lifter 530, pick-up unit 526 may be constructed in the same manner as the gripper 122 of pick-up unit 44 described above and shown in FIG. 8. An air source such as 114 and a pneumatic manifold such as 116 would be used to provide air as required to the pneumatic cylinder such as 128 used to open or close the gripper's legs. The structures such as plate 100, plate 104, side walls 108, pneumatic cylinders 110 and 112, and sensor units 118 and 120 can be excluded from pick-up unit 526 because it is not necessary to make pick-up unit 526 vertically mobile independent of Z-axis lifter 530. However, it should be understood that pick-up unit 526 could be constructed identically to pick-up unit 44 if desired.

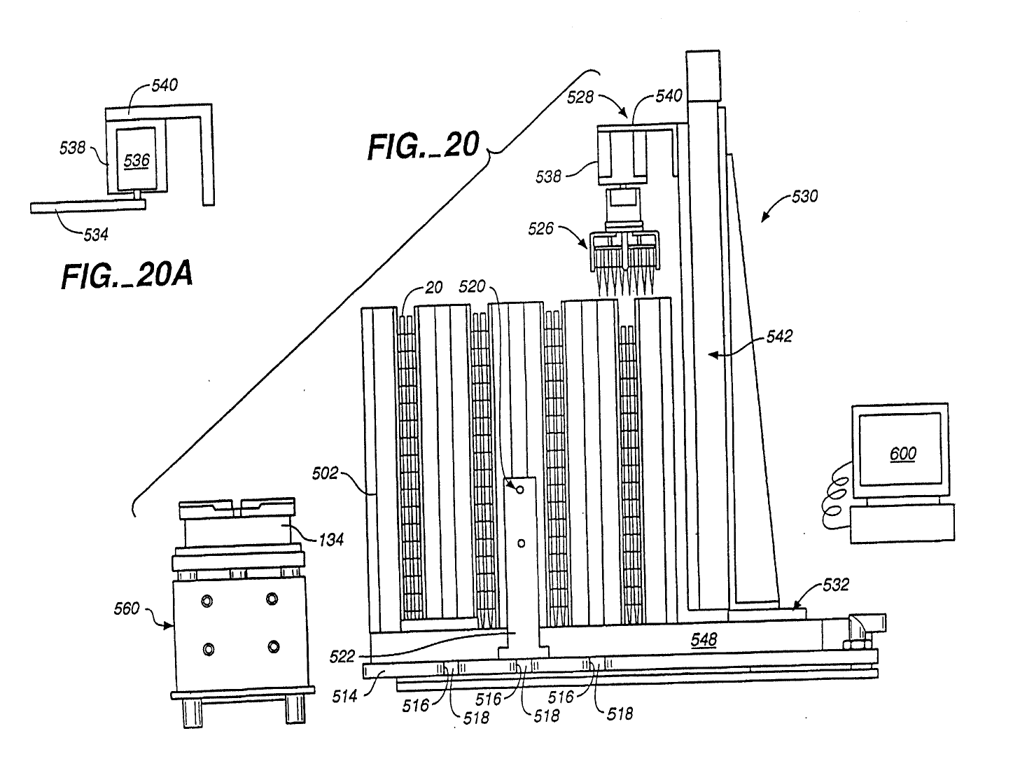

Referring to FIG. 20A, rotator assembly 528 preferably comprises a rotator arm 534, rotation means 536 for turning rotator arm 534 through at least 180 degrees, a rotator shaft 538 housing the rotation means 536, and an L-shaped plate 540 fixable to the Z-axis lifter 530. Pick-up unit 426 may be secured to the rotator arm 434 of the rotator assembly 428 by a bolt or the like. Rotator arm 534 is fixed to the rotation means 536, which may be a stepping motor or servomotor as is well known in the art. Rotation means 536 is housed within rotator shaft 538, which is secured to L-shaped plate 540.

In the second embodiment, Z-axis lifter 430 comprises a Z-axis drive housing 542, a Z-axis jackscrew 544 disposed within Z-axis drive housing 542, and a Z-axis servomotor 546 controlling Z-axis jackscrew 544. The L-shaped plate 540 of rotator assembly 428 is then movably secured to Z-axis jackscrew 544.

In the second embodiment, X-axis driver 432 comprises an X-axis drive housing 548, an X-axis jackscrew 550 disposed within X-axis drive housing 548, and an X-axis servomotor 552 controlling X-axis jackscrew 550. Z-axis drive housing 542 of Z-axis lifter 430 is then movably secured to X-axis jackscrew 550.

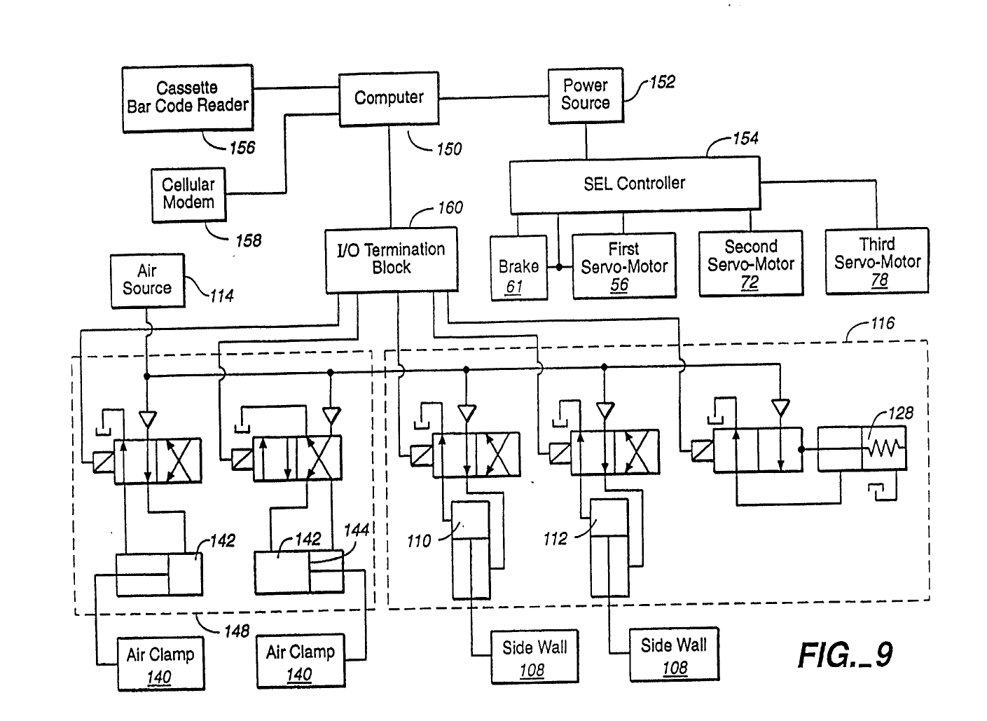

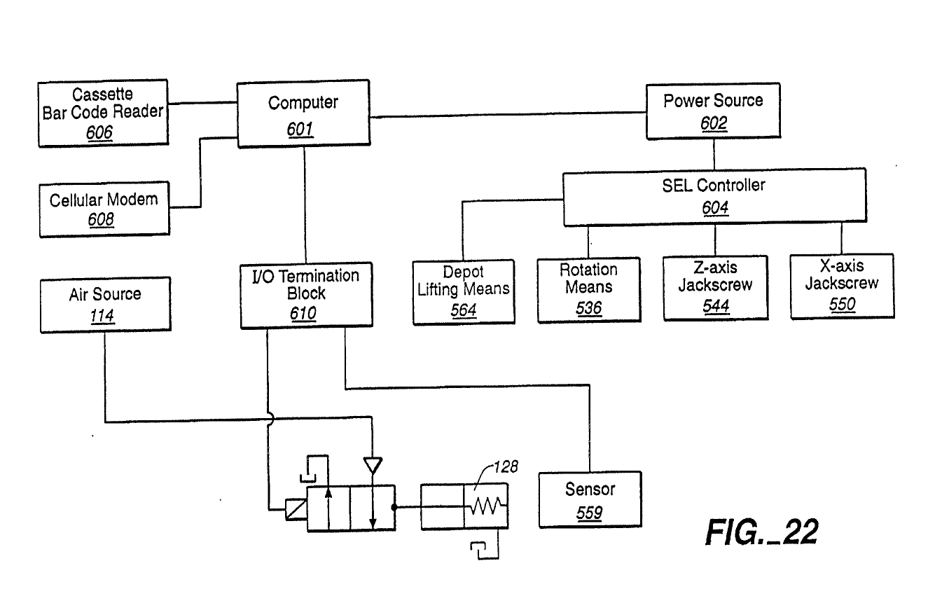

Pipette tip flats 20 stored or dispensed by the second embodiment 500 of the inventive system are preferably delivered to one or more of the special tip depots 134 designed to lock the flats 20 into place on the tip depot 134, as was described above for the first embodiment (see FIGS. 10-12). Note that the pick-up unit 526 of this embodiment should and does incorporate the features of the gripper 122 of pick-up unit 44 of the first embodiment which correspond to the features of the special tip depot 134. Preferably tip depot 134 incorporates a sensor unit 559 (see FIG. 22) which is triggered when a flat 20 has been captured in the tip depot 134 by capture blades 408.

Each special tip depot 134 used with the inventive system may be mounted on a separate tip mounter 560 which can be controlled to raise or lower the special tip depot 134 along the Z-axis. This special tip mounter 560 is particularly useful when processing pipette tip flats 20 for delivery to or reception from a pipettor which does not provide its own vertical movement when picking up pipette tips from the pipette tip flat 20. Tip mounter 560 preferably comprises a platform 562 upon which the tip depot 134 rests and which is secured to a depot lifting means 564 for raising and lowering platform 562. Depot lifting means 564 may operate using devices including, but not limited to, jackscrews or pneumatic or hydraulic cylinders, as is well known in the art.

Referring to FIG. 22, a control system 600, similar to control system 18 of the first embodiment, is used to control robotic device 524 during automated storing or dispensing of pipette tip flats 20. Control system 600 communicates by signals with the pneumatic manifold of pick-up unit 526 to open and close the gripper arms which engage individual pipette tip flats 20 in the stacks 504, with rotation means 536 to rotate rotator arm 534 and pick-up unit 526, with Z-axis jackscrew 544 to raise and lower rotator assembly 528 and pick-up unit 526, and with X-axis jackscrew 550 to move Z-axis lifter 430, rotator assembly 528, and pick-up unit 526 forward and backward along the X axis. Like control system 18, control system 600 may utilize an industrial PC 601 receiving its power from a power source 602 used to power any other applications in the system, and is preferably located nearby robotic device 524 at an accessible station. Control system 600 again has input devices for human control of the automated processes, including but not limited to a keyboard and a touchscreen 604, such as that operated by the SELwin system described above. The touchscreen 604 may be directly used to control rotation means 536, Z-axis jackscrew 544, X-axis jackscrew 550, and depot lifter means 564. Preferably control system 600 also incorporates a cassette bar code reader 606 and a cellular modem 608 which can be used for the same purpose described for the first embodiment with bar codes marked upon cassettes 502.

The I/O termination block of control system 600 sorts and sends out signals as discrete inputs and outputs corresponding to various controls of the components of robotic device 524. Discrete outputs include, but are not limited to: an emergency stop signal, a ready signal, a run signal, a cycle complete signal, and signals to close and open the gripper legs of pick-up unit 526. Discrete inputs include, but are not limited to: an emergency stop signal generated from the robotic device 524; an emergency stop signal generated from a remote source such as the cellular modem 608 or from another controller with which control system 600 communicates; a signal from sensor 559 that a flat has been captured in the tip depot 134; a pipettor ready signal indicating that a robotic pipettor is in position to deliver or receive flats 20; a signal indicating that the loading area of the robotic pipettor is clear; a signal from the pipettor that it has received or delivered pipette tips to the flat 20; and a signal from the air source used in operating the pneumatic gripper legs of the pick-up unit 526 that air is available. I/O device 610 controls the pneumatic manifold which controls the air cylinder used to open and control the pneumatic gripper legs.

Control system 600 is programmed to load and/or unload cassettes 502 according to the process steps described as follows. The automated system 500 can be operated in either automatic or manual mode. The general flowchart for the overall operation of the inventive system 500 is identical to that described above in relation to control system 18, and is depicted as a progressive flowchart in FIG. 13. If an automated locking system as described for the first embodiment of the inventive system is applied to system 500, similarly the flowchart for the operation of a cassette locking program described for control system 18 and shown in FIG. 15 may be used. The flowchart for the Alarm Management Task of system 500 is identical to that described above in relation to control system 18, and is shown as a progressive flowchart in FIG. 17.

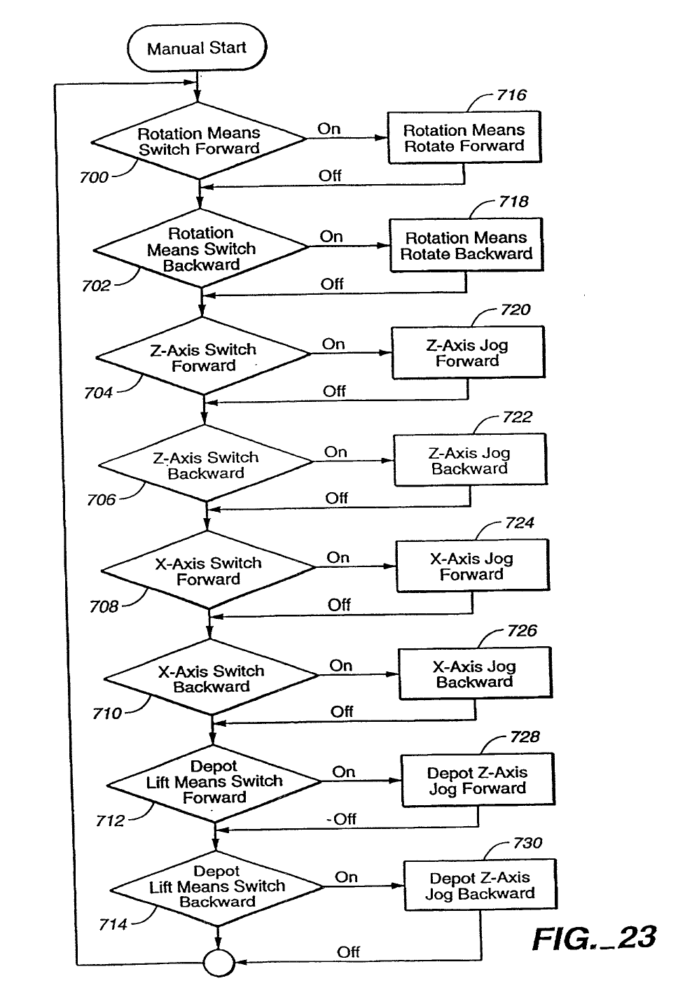

FIG. 23 is a sequential flowchart of the manual task system used in control system 600. While the manual task system is activated, control system 600 loops through a set of decision blocks corresponding to manual switches controlling movements of the rotation means, the Z-axis jackscrew, the X-axis jackscrew, and the depot lift means: a rotation means switch forward 700, a rotation means switch backward 702, a Z-axis switch forward 704, a Z-axis switch backward 706, an X-axis switch forward 708, an X-axis switch backward 710, a depot lift means switch forward 712, and a depot lift means switch backward 714. At each of these decision blocks, if the manual switch is activated, the control system signals the jackscrew, stepping motor, servomotor, pneumatic manifold, or other means controlling that device accordingly. Thus, if the Z-axis switch forward is activated at decision block 704, at operation block 720 control system 600 causes jackscrew 544 to rotate in the direction defined as forward. Note that for each decision block, the direction defined as “forward” and the direction defined as “backward” can be chosen as is convenient, whether indicating motion up or down, clockwise or counterclockwise, etc. as long as it is consistent. Operation blocks 716, 718, 722, 724, 726, 728, and 730 similarly correspond to decision blocks 700, 702, 706, 708, 710, 712, and 714, respectively.

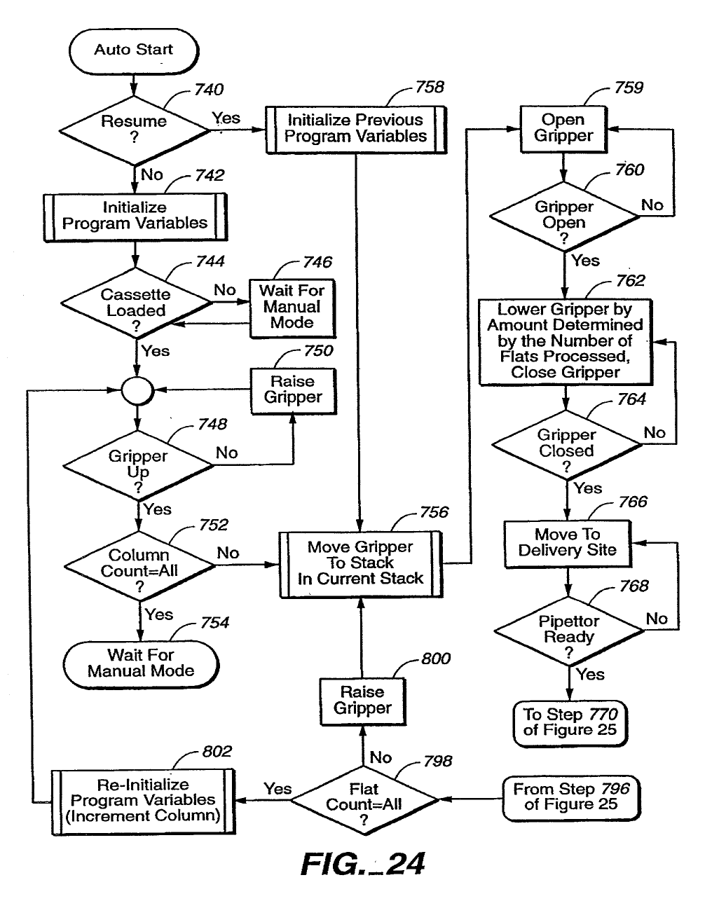

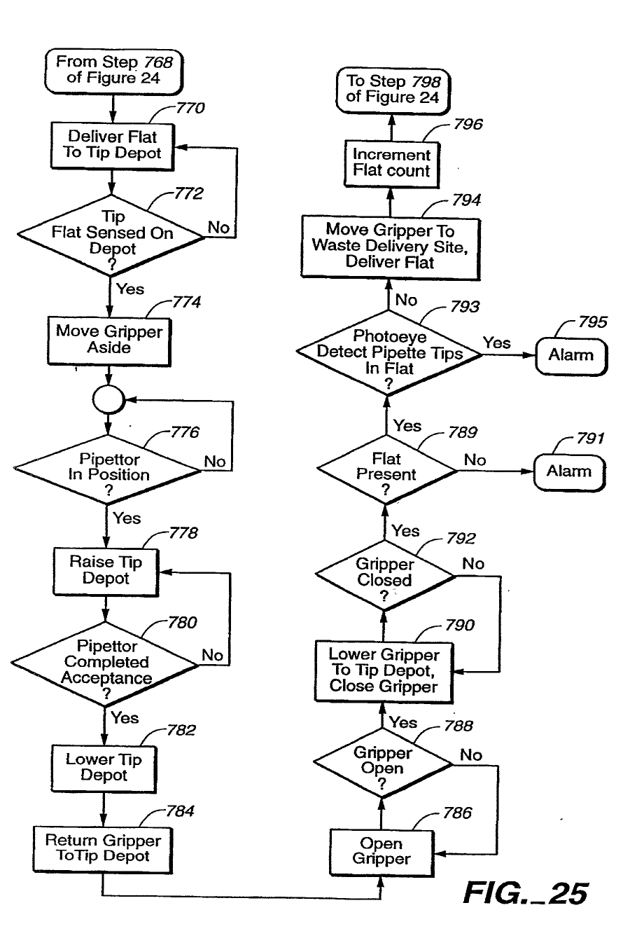

FIGS. 24 and 25 show the automated task system implemented by control system 600. It will be assumed that the inventive system 500 here is being used to unload flats 20 containing clean pipette tips from one cassette 502, deliver them to tip depot 134 where the pipette tips are removed from the flat 20 by a pipettor, pick up the empty pipette tip flat 20 from the tip depot 134, and eject the empty pipette tip flat 20 to a waste site. However, it should be understood that the automated task system of this embodiment can complete other tasks, including but not limited to loading flats of dirty pipette tips returned by a pipettor to a flat at tip depot 134 into a cassette 502, or unloading multiple cassettes 502 of flats 20 of clean pipette tips.

At decision block 740, the control system 600 determines whether it is starting a new loading or unloading process, or is resuming an old loading or unloading process. If the process is new, at operation block 742 the program variables are initialized. Program variables include, but not limited to, the number of flats 20 in a stack 504, the number of stacks in the column of the cassette 502, and the number of flats and stacks of the cassette which have already been processed (initially zero). At decision block 744 the control system determines whether the cassette 14 is loaded into the robotic device 524. If not, at operation block 746 the control system 600 waits for manual mode and initiation of the manual loading task. It should be noted that if an automated cassette loading process is used operation block 746 could instead trigger an automated cassette loading task. Once control system 600 has determined that a cassette 502 is loaded into robotic device 524, it starts the cassette loading or unloading process.

At decision block 748, control system 600 determines whether the pick-up unit 526 has been “raised” by moving the pick-up unit 526 and rotator unit 528 to the highest point on the Z-axis using jackscrew 544. If not, at operation block 750 control system 600 raises the pick-up unit 526. Once the pick-up unit 526 is raised, the control system 600 determines whether all of the stacks 504 of flats 20 in the cassette's column have been processed at decision block 752. If they have been, the loading or unloading process is complete at block 754 and the control system 18 waits for manual mode to await insertion of another cassette 14 and resumption of the process, or, alternatively can move the pick-up unit 526 into position to process another cassette 502 and restart the process at decision block 740. If not, the control system 600 starts to load or unload the next stack 504 of flats 20 at operation block 756.

If the control system 600 determined at decision block 740 that the loading or unloading process to be undertaken is a resumption of an earlier started process, the control system 600 at operation block 758 reinitializes the program variables to the values held when the process was suspended. The control system then proceeds to operation block 756 to resume loading or unloading flats 20 from the current stack 504.

At operation block 756, control system 600 moves the Z-axis lifter 530 along the X-axis driver 532 using X-axis jackscrew 550 until pick-up unit 526 is in position above the correct stack 504 in the column of stacks 504 for the cassette 502. Control system 600 uses the program variables to determine the longitudinal and elevational position of the current stack 504 to be processed.

The control system then picks up or drops off a flat 20 from that stack 504. FIG. 16 shows the process for a cassette unloading process; the cassette loading process is conducted in similar fashion in approximately reverse order. At operation block 758, the gripper legs 130 of the pick-up unit 526 are opened. Decision block 760 determines whether the legs 130 successfully opened fully. If not, operation block 758 is repeated. If so, the pick-up unit 526 is lowered at operation block 762 by activating Z-axis jackscrew 544 by an increment determined by the program variables to move the pick-up unit into position to secure the next flat 20 in the stack 504, and the gripper legs 130 are closed. Decision block 764 determines whether the gripper legs 130 successfully closed fully. If not, operation block 762 is repeated. If so, a flat 20 has been secured in the gripper legs 130, and at operation block 766 the control system 600 moves the pick-up unit into position over the tip depot 134. Preferably, the control system does this by activating the Z-axis jackscrew 544 to lift the pick-up unit 526 to its raised position, activating the X-axis jackscrew to move the entire Z-axis assembly to its furthest forward position along the X-axis, and activates the rotation means 536 to rotate the pick-up unit 526 through approximately ninety degrees into position over the tip depot 134. Assuming the flats 20 delivered to tip depot 134 are picked up by a robotic pipettor, at decision block 768 the control system 18 determines whether it has received a ready signal for delivery of a flat from the robotic pipettor. If not, operation block 766 is repeated. If so, the flat 20 is delivered by pick-up unit 44 to the tip depot 134 of the pipettor at operation block 770.

If the pipettor is itself able to retrieve and process entire flats from the tip depot, the automated assembly process may move directly to step 798. However, if the pipettor requires that the tip depot be lifted vertically to the pipettor, and the pipettor leaves an emptied flat 20 on the tip depot 134, the following steps are followed. At decision block 772, control system 600 determines whether a flat 20 has been sensed as received by the tip depot 134, using signals received from sensor 559. If not, operation block 770 is repeated. If so, at operation block 774 the pick-up unit 526 is moved away from above the tip depot 134, preferably by activating rotation means 536. At decision block 776, control system 600 determines whether the pipettor is in position for receipt of the pipette tips upon raising the flat, such as by awaiting the receipt of a signal from the pipettor's controller. If not, the system repeats the inquiry until the pipettor is in position. If so, at operation block 778, control system 600 activates depot lifting means 564 to raise the tip depot 134, allowing the pipettor to engage the pipette tips on the flat 20. At decision block 780, control system 600 then determines whether the pipettor has successfully removed the pipette tips from the pipette tip flat 20 deposited upon the tip depot 134. If not, operation block 778 is repeated. If so, the tip depot 134 is lowered by activating depot lifting means 564, and the pick-up unit 526 is returned into position over tip depot 134 to pick up the emptied flat 20. Note that if it is desired that the pipettor return the dirtied pipette tips to the flat 20 before the flat 20 is removed from the tip depot 134, the additional steps of awaiting a signal from the pipettor that the dirtied tips are ready to be deposited into the flat 20, lifting the tip depot up to the pipettor until the pipette tips are redeposited into the flat 20, and lowering the tip depot 134 may be added at this point.

At operation block 786, gripper legs 130 are opened so that the flat 20 present on the tip depot 134 may be picked up by pick-up unit 526. Decision block 788 determines whether the legs 130 successfully opened fully. If not, operation block 786 is repeated. If so, at operation block 790 pick-up unit 526 is lowered to the tip depot 134 by activating Z-axis jackscrew 544, and the gripper legs 130 are closed about the empty flat 20 by activating the pneumatic manifold controlling the gripper legs 130. At decision block 792, control system 600 determines whether the gripper legs have successfully closed. If not, operation block 790 is repeated. If so, at decision block 789, control system 600 determines whether a flat is present in gripper legs 130. If not, control system signals an error alarm at operation block 791 and awaits user input.

If a flat is present in gripper legs 130, at decision block 793, control system 600 determines whether the pipette tips have successfully been removed from the flat 20 by passing the pipette tip flat underneath a photo eye. If pipette tips are detected in the flat, control system 600 will signal an error alarm at operation block 795. Note that alternatively, if it is desired that the pipettor return dirty pipette tips to the flat 20 before the flat is removed from tip depot 134, control system may alternatively signal an error alarm if no pipette tips are detected in the flat, and proceed with delivery of the filled flats 20 if pipette tips are detected in the flat by the photo eye.

Assuming that it is desired that flats 20 are emptied, if no pipette tips are detected in flat 20, at operation block 794 control system 600 moves pick-up device 526 into position over a empty flat depository site. This may simply be a bin 590 located at some location over which pick-up unit 526 may be passed, such as by rotating pick-up unit 526 approximately halfway between cassette 502 and tip depot 134. However, it should be understood that empty flats 20 could themselves be reloaded into a bay of an empty cassette 502 also accessible to robotic device 524. Indeed, if flats 20 are alternatively filled with dirty pipette tips it is preferred that the flats filled with dirty pipette tips be reloaded into a bay of an empty cassette 502.

Once pick-up unit 526 is moved into position over the waste bin 590, or, if filling an empty cassette 502, pick-up unit has been moved into the appropriate bin 506 of the empty cassette 502, the gripper legs 130 are opened to release the flat 20. The control system 600 then updates the program variables to reflect that another flat 20 from the current stack 504 has been processed.

At decision block 798, control system 600 then determines whether all of the flats 20 in the current stack 502 have been processed, according to the program variables. If not, the pick-up unit 526 is raised at operation block 800, and the processing of flats 20 from the current stack 504 is resumed at operation block 756. If not, the program variables are reinitialized for a new stack at operation block 802, and processing of the next stack 504 is started at decision block 748.

Note that the automated task system has been described where the flats are successively taken from or delivered to a single stack 504 until the stack 504 has been depleted or filled before moving to the next stack 504 of the column. It should be understood that the automated task system could follow another process for filling or depleting all the stacks 504, such as processing one flat 20 from each stack 504 successively, and then repeating this process until all levels of flats 20 in each stack have been processed.

Further, although the foregoing invention has been described in some detail by way of illustration for purposes of clarity of understanding, it will be readily apparent to those of ordinary skill in the art in light of the teachings of this invention that certain changes and modifications may be made thereto without departing from the spirit or scope of the appended claims.

It is claimed:

1. A system for the automated storing or dispensing of one or more stacks of stackable goods, comprising:
at least one pick-up site at which one or more stacks of stackable goods may be stationed, such that a stackable good may be retrieved from the top of each stack positioned at the pick-up site;
at least one delivery site at which one or more stacks of stackable goods may be stationed, such that a stackable good may be deposited upon the top of each stack positioned at the delivery site;
a robotic device comprising pick-up means for securing and releasing one of the stackable goods, and movement means for moving the pick-up means into position to retrieve one of the stackable goods from the top of any stack stationed at any pick-up site, and for moving the pick-up means into position to deposit one of the stackable goods upon any stack stationed at any delivery site; and
a control system communicating with the robotic device such that the control system can activate the pick-up means and the movement means of the robotic device, the control system programmed to be operable to systematically move the stacks of stackable goods between the one or more pick-up sites and the one or more delivery sites.
